(19) United States
(12) Patent Application Publication
(10) Pub. No.: US 2025/0039400 A1
(43) Pub. Date: Jan. 30, 2025

(54) VIDEO SIGNAL PROCESSING METHOD USING OBMC, AND DEVICE THEREFOR

(71) Applicant: WILUS INSTITUTE OF STANDARDS AND TECHNOLOGY INC., Gyeonggi-do (KR)

(72) Inventors: Kyungyong KIM, Gyeonggi-do (KR); Dongcheol KIM, Gyeonggi-do (KR); Juhyung SON, Gyeonggi-do (KR); Jinsam KWAK, Gyeonggi-do (KR)

(21) Appl. No.: 18/692,814

(22) PCT Filed: Sep. 19, 2022
(86) PCT No.: PCT/KR2022/013993

§ 371 Date: Oct. 17, 2024

(30) Foreign Application Priority Data
Sep. 17, 2021 (KR) 10-2021-0125137
Oct. 8, 2021 (KR) 10-2021-0134289
Jun. 27, 2022 (KR) 10-2022-0078491
Jul. 6, 2022 (KR) 10-2022-0083184
Jul. 15, 2022 (KR) 10-2022-0087811

(51) Int. Cl. H04N 19/14; H04N 19/105; H04N 19/176

(52) U.S. Cl. CPC H04N 19/14; H04N 19/105; H04N 19/176

(57) ABSTRACT

The video signal decoding device comprises a processor, wherein the processor acquires first motion information about the current sub block, acquires second motion information about a first neighboring block from among neighboring blocks of the current sub block, acquires third motion information about a second neighboring block from among the neighboring blocks, acquires a first prediction block based on the first motion information, acquires a second prediction block based on the second motion information, acquires a third prediction block based on the third motion information, and acquires a final prediction block for the current sub block.

### TECHNICAL FIELD

The present disclosure relates to a video signal processing method and device and, more specifically, to a video signal processing method and device by which a video signal is encoded or decoded.

### BACKGROUND ART

Compression coding refers to a series of signal processing techniques for transmitting digitized information through a communication line or storing information in a form suitable for a storage medium. An object of compression encoding includes objects such as voice, video, and text, and in particular, a technique for performing compression encoding on an image is referred to as video compression. Compression coding for a video signal is performed by removing excess information in consideration of spatial correlation, temporal correlation, and stochastic correlation. However, with the recent development of various media and data transmission media, a more efficient video signal processing method and apparatus are required.

### DISCLOSURE OF INVENTION

### Technical Problem

The purpose of the present disclosure is to provide a video signal processing method and a device therefor, so as to increase the coding efficiency of a video signal.

### Solution to Problem

The present disclosure provides a video signal processing method and a device therefor.

According to the present disclosure, a video signal decoding device includes a processor, wherein the processor is configured to acquire first motion information of a current sub-block, acquire second motion information about a first neighboring block among neighboring blocks of the current sub-block, acquire third motion information about a second neighboring block among the neighboring blocks, acquire a first prediction block based on the first motion information, acquire a second prediction block based on the second motion information, acquire a third prediction block based on the third motion information, identify whether OBMC is applied to the current sub-block, when the OBMC is applied to the current sub-block, select one or more prediction blocks which satisfy a preconfigured condition among the second prediction block and the third prediction block, and perform the OBMC based on the one or more prediction blocks and the first prediction block to acquire a final prediction block for the current sub-block. A CIIP mode may be applied to the current sub-block, the current sub-block may be divided into an inter prediction block of the current sub-block based on an inter prediction mode and an intra prediction block of the current sub-block based on an intra prediction mode, the intra prediction block may be a block in a first domain, the inter prediction block may be a block in a second domain, the one or more prediction blocks may be blocks in the second domain, and the first domain and the second domain may be different domains. The processor is configured to perform forward mapping on the inter prediction block to acquire an inter prediction block in the first domain, perform the forward mapping on the one or more prediction blocks to acquire one or more prediction blocks in the first domain, and perform weight-averaging of the inter prediction block, the intra prediction block in the first domain, and the one or more prediction blocks in the first domain to acquire a final prediction block of the current sub-block.

In addition, according to the present disclosure, a video signal encoding device may include a processor, wherein the processor is configured to acquire a bitstream decoded by a decoding method. In addition, according to the present disclosure, in a computer-readable non-transitory storage medium storing a bitstream, the bitstream may be decoded by a decoding method. The decoding method may include: acquiring first motion information of a current sub-block; acquiring second motion information about a first neighboring block among neighboring blocks of the current sub-block; acquiring third motion information about a second neighboring block among the neighboring blocks; acquiring a first prediction block based on the first motion information; acquiring a second prediction block based on the second motion information; acquiring a third prediction block based on the third motion information; identifying whether OBMC is applied to the current sub-block; when the OBMC is applied to the current sub-block, selecting one or more prediction blocks which satisfy a preconfigured condition among the second prediction block and the third prediction block; and performing the OBMC based on the one or more prediction blocks and the first prediction block to acquire a final prediction block for the current sub-block. In addition, a CIIP mode may be applied to the current sub-block, the current sub-block may be divided into an inter prediction block of the current sub-block based on an inter prediction mode and an intra prediction block of the current sub-block based on an intra prediction mode, the intra prediction block may be a block in a first domain, the inter prediction block may be a block in a second domain, the one or more prediction blocks may be blocks in the second domain, and the first domain and the second domain may be different domains. The decoding method may include: performing forward mapping on the inter prediction block to acquire an inter prediction block in the first domain; performing the forward mapping on the one or more prediction blocks to acquire one or more prediction blocks in the first domain; and performing weight-averaging of the inter prediction block, the intra prediction block in the first domain, and the one or more prediction blocks in the first domain to acquire a final prediction block of the current sub-block.

In addition, according to the present disclosure, the preconfigured condition corresponds to a condition based on a first similarity between the first prediction block and the second prediction block and a second similarity between the first prediction block and the third prediction block.

In addition, according to the present disclosure, the one or more prediction blocks are prediction blocks corresponding to a similarity determined by comparing each of a value indicating the first similarity and a value indicating the second similarity with a preconfigured value.

In addition, according to the present disclosure, the one or more prediction blocks are prediction blocks corresponding to a similarity smaller than a preconfigured value by comparing each of a value indicating the first similarity and a value indicating the second similarity with the preconfigured value.

In addition, according to the present disclosure, the final prediction block is acquired by performing weight-averaging of the one or more prediction blocks and the first prediction block.

In addition, according to the present disclosure, when the OBMC is applied to at least one block among the current sub-block, the second prediction block, and the third prediction block, deblocking filtering is not performed on the current sub-block.

In addition, according to the present disclosure, the current sub-block is included in a coding block, the current sub-block is a sub-block which does not include a boundary of the coding block, the neighboring blocks are included in the coding block, the neighboring blocks are sub-blocks including the boundary of the coding block, and when the number of blocks to which the OBMC is applied among the neighboring blocks is smaller than a first value, the OBMC is not applied to the current sub-block.

In addition, according to the present disclosure, whether the OBMC is applied to the current sub-block is determined by a syntax element included in a bitstream.

In addition, according to the present disclosure, the syntax element is signaled at an SPS level.

In addition, according to the present disclosure, a GPM mode is applied to the current sub-block, the current sub-block is divided into a first area and a second area, and when at least one area among the first area and the second area is encoded in an intra mode, the OBMC is not applied to the current sub-block.

In addition, according to the present disclosure, when neighboring blocks adjacent to the first area are blocks which are pre-reconstructed, and neighboring blocks adjacent to the second area are blocks which are not pre-reconstructed, the final prediction block is acquired based on motion information of the first area.

### Advantageous Effects of Invention

The present disclosure provides a method for efficiently processing a video signal.

The effects obtainable from the present specification are not limited to the effects mentioned above, and other effects not mentioned may be clearly understood by to those skilled in the art, to which the present disclosure belongs, from the description below.

### BRIEF DESCRIPTION OF DRAWINGS

FIG. 1 is a schematic block diagram of a video signal encoding apparatus according to an embodiment of the present invention.

FIG. 2 is a schematic block diagram of a video signal decoding apparatus according to an embodiment of the present invention.

FIG. 3 shows an embodiment in which a coding tree unit is divided into coding units in a picture.

FIG. 4 shows an embodiment of a method for signaling a division of a quad tree and a multi-type tree.

FIGS. 5 and 6 illustrate an intra-prediction method in more detail according to an embodiment of the present disclosure.

FIG. 7 illustrates the position of neighboring blocks used to construct a motion candidate list in inter prediction.

FIG. 8 illustrates a process of performing OBMC according to an embodiment of the present disclosure.

FIG. 9 illustrates a method of performing OMBC in the unit of a CU according to an embodiment of the present disclosure.

FIG. 10 illustrates a method of performing OBMC in the unit of a sub-block according to an embodiment of the present disclosure.

FIG. 11 illustrates a table in which a weight is defined according to an embodiment of the present disclosure.

FIGS. 12 to 14 illustrate a method of selectively using a neighboring block when performing OBMC, according to an embodiment of the present disclosure.

FIG. 15 illustrates a method of determining a strength of deblocking filtering when performing OBMC, according to an embodiment of the present disclosure.

FIG. 16 illustrates a method of configuring a template for performing OBMC, according to an embodiment of the present disclosure.

FIG. 17 illustrates a method of generating a prediction block according to each OBMC mode according to an embodiment of the present disclosure.

FIGS. 18 to 20 illustrate a process of performing OBMC according to an embodiment of the present disclosure.

FIG. 21 illustrates a GPM mode according to an embodiment of the present disclosure.

FIG. 22 illustrates a method of dividing a GPM mode according to an embodiment of the present disclosure.

FIG. 23 illustrates a method of signaling information indicating whether OBMC in the unit of a sub-block is activated, according to an embodiment of the present disclosure.

FIG. 24 illustrates a method of signaling information indicating the maximum block size for activation of OBMC according to an embodiment of the present disclosure.

FIG. 25 illustrates a method of signaling information for activating blending in a GPM mode according to an embodiment of the present disclosure.

FIG. 26 illustrates a method of generating a prediction block of a current block by using a CIIP mode according to an embodiment of the present disclosure.

FIGS. 27 to 32 illustrate a method in which OBMC is applied to a prediction block according to CIIP, according to an embodiment of the present disclosure.

FIG. 33 illustrates a context model according to an embodiment of the present disclosure.

FIG. 34 illustrates an LMCS method according to an embodiment of the present disclosure.

FIG. 35 illustrates a method of acquiring a prediction block of a current sub-block according to an embodiment of the present disclosure.

### BEST MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luminance”, “Y”, and the like may be used interchangeably in this specification. Additionally, in the present specification, the terms “chroma”, “chrominance”, “Cb or Cr”, and the like may be used interchangeably, and chroma components are classified into two components, Cb and Cr, and thus each chroma component may be distinguished and used. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

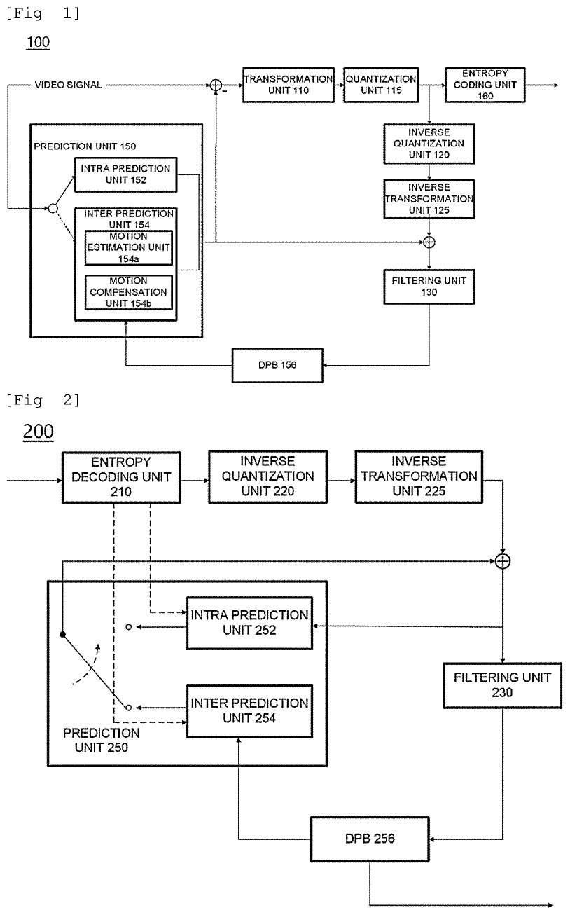

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2N×2N, an error signal may be present only in the first 2N×N block, and the transform process may be performed on the first 2N×N block. However, the second 2N×N block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LENST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the inverse transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending on the strength of deblocking filtering. Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160. The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract transform coefficient information, intra encoding information, inter encoding information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 restores a residual value by using the inverse-quantized transform coefficient. The video signal processing device 200 restores an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the intra encoding information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the above right (AR) block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and the residual outputted the inverse value from transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A sub-picture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

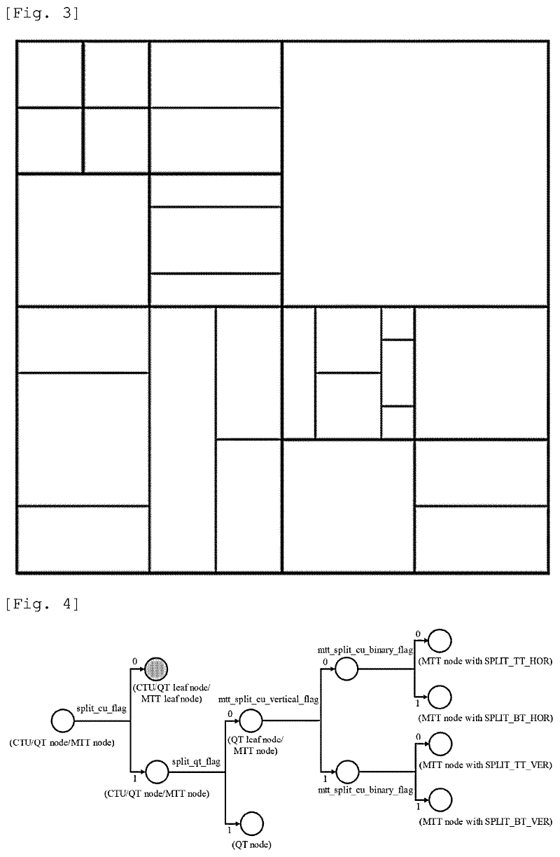

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not be constant. The coding unit may have a square or rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2N×2N size in a quad tree structure may be split into four nodes having an N×N size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2N×2N size may be split into two N×2N nodes by vertical binary split, and split into two 2N×N nodes by horizontal binary split. In addition, in a ternary tree (TT) structure, a node of a 2N×2N size is split into (N/2)×2N, N×2N, and (N/2)×2N nodes by vertical ternary split, and split into 2N×(N/2), 2N×N, and 2N×(N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’ indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad tree or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt_split_flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra encoding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

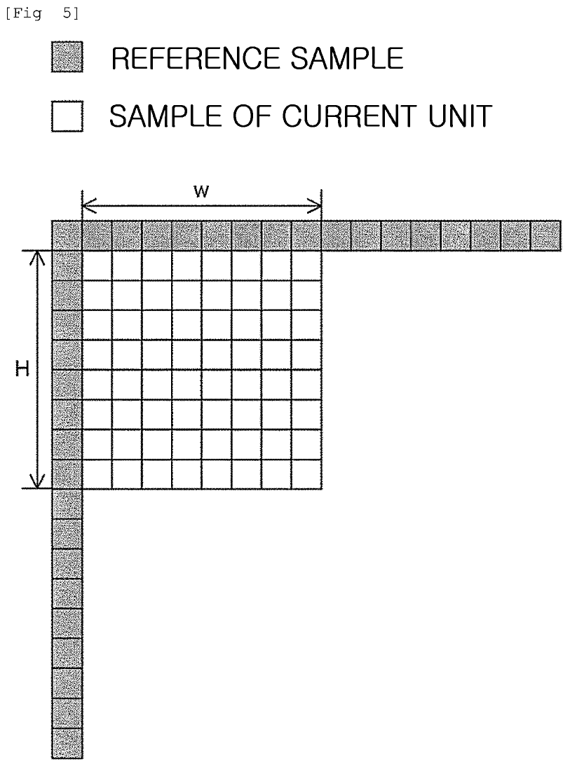

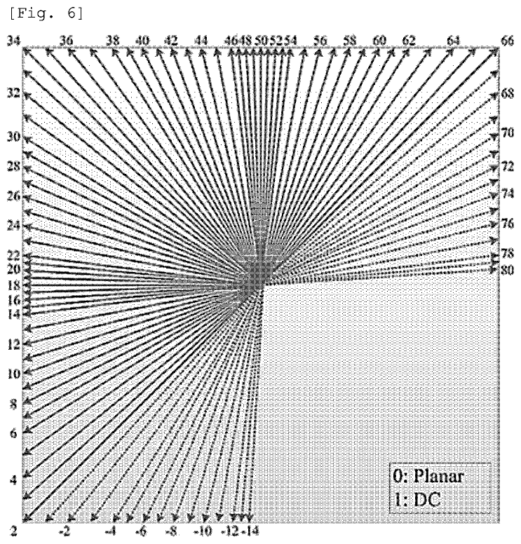

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is W×H and samples of a single reference line adjacent to the current block are used for intra prediction, reference samples may be configured using a maximum of 2 W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been restored, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than-135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45-offset2) degrees and (−135-offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}. That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65} can be determined on the basis of the spacing between the corresponding basic angle modes {2, 4, 6, . . . , 66}. In addition, the spacing between the extended angle modes {−14, −13, . . . , −1} can be determined on the basis of the spacing between corresponding basic angle modes {53, 54, . . . , 66} on the opposite side, and the spacing between the extended angle modes {67, 68, . . . , 80} can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1} can be signaled by the intra prediction mode indices {52, 53, . . . , 66}, respectively, and the wide angle modes {67, 68, . . . , 80} can be signaled by the intra prediction mode indices {2, 3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_l0, ref_idx_l1), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1=0 may be set. For a unidirectional prediction using an L1 reference picture, predFlagL0=0 and predFlagL1=1 may be set. For bidirectional prediction using both the L0 and L1 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, ¼ pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, ¼ pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different, and information about the weights is signaled via BCW_IDX.

In order to improve the accuracy of the motion vector predictor, a merge or AMVP (advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of the current block, and then signaling index information for the optimal motion candidate. In the case of AMVP, motion candidate lists are derived for L0 and L1, respectively, so the most candidate indexes (mvp_l0_flag, optimal motion mvp_l1_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

Bidirectional motion information for the current block may be derived by mixing AMVP and Merge modes. For example, motion information in the L0 direction may be derived using the AMVP method, and motion information in the L1 direction may be derived using the Merge method. Conversely, Merge may be applied to L0 and AMVP to L1. This encoding mode may be called AMVP-merge mode.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already restored reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

The cross-component linear model (CCLM) is a method that constructs a linear model by using the high correlation between a luma signal and a chroma signal at the same position as the luma signal, and then predict the chroma signal by using the linear model. A template is constructed using a block, which has been completely reconstructed, among neighboring blocks adjacent to a current block, and parameters for the linear model are derived through the template. Next, a current luma block, selectively reconstructed based on video formats so as to fit the size of a chroma block, is downsampled. Finally, the downsampled luma block and the corresponding linear model are used to predict a chroma block of the current block. In this case, a method using two or more linear models is referred to as multi-model linear mode (MMLM).

In independent scalar quantization, a reconstructed coefficient t′ₖ for an input coefficient tₖ depends only on a related quantization index qₖ. That is, a quantization index for a random reconstructed coefficient has a different value from quantization indexes for other reconstructed coefficients. Here, t′ₖ may be a value that includes a quantization error in tₖ, and may be different or the same depending on quantization parameters. Here, t′ₖ may be called a reconstructed transform coefficient or a dequantized transform coefficient, and the quantization index may be called a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters.

In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. TO reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (B0) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in the present specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

FIG. 8 illustrates a process of performing OBMC according to an embodiment of the present disclosure.

Referring to FIG. 8, a decoder may acquire motion information (e.g., a motion vector) of a current block (e.g., a current coding unit) and motion information of neighboring blocks of the current block (S810). The decoder may determine whether OBMC is applied to a sub-block of the current block (S820). In this case, the decoder may determine whether the OMBC is applied to each sub-block. When an affine mode (e.g., a merge-based affine mode and an AMVP-based affine mode), a subblock-based temporal motion vector predictors (sbTMVP) mode, or a multi-pass decoder-side motion vector refinement (MP-DMVR) mode is applied to the current block, the decoder may determine that the OBMC is applied to the sub-block of the current block. This is because motion information between sub-blocks may be different when the affine mode, the sbTMVP mode, or the MP-DMVR mode is applied to the current block. The decoder may perform OBMC in the unit of a CU (S830). The OBMC in the unit of a CU may be performed independently for each sub-block including an upper boundary and a left boundary of the current block. Specifically, the decoder may divide the current block into sub-blocks. In this case, the size of each sub-block may be a predetermined size and have a positive value. For example, the predetermined size may be 4. The decoder may perform OBMC in the unit of a sub-block, based on whether the OBMC is applied to the sub-block of the current block (S840). That is, when the decoder determines that the OBMC is applied to the sub-block, the decoder may perform the OBMC in the unit of a sub-block. The OBMC in step S840 may be performed on a sub-block of a current block unit which does not include upper/left boundaries. That is, the OBMC may be performed on the remaining sub-blocks other than the sub-block on which the OBMC is performed in step S830. The decoder may perform the OBMC on the sub-block of the current block and acquire a prediction block of the current block (S850).

Hereinafter, the step S830 will be described in more detail. The decoder may determine whether motion information of a first sub-block of the current block and motion information of a neighboring block of the first sub-block are the same. When the pieces of motion information are different from each other, the decoder may perform the OBMC on the first sub-block. In addition, the decoder may determine whether motion information of a second sub-block of the current block and motion information of a neighboring block of the second sub-block are the same. Likewise, when the pieces of motion information are different from each other, the decoder may perform the OBMC on the second sub-block. In this case, when the motion information of the first sub-block and the motion information of the second sub-block are the same, and the motion information of the neighboring block of the first sub-block and the motion information of the neighboring block of the second sub-block are the same, the decoder may perform the OBMC after grouping the first sub-block and the second sub-block into one sub-block. This has an effect of reducing the number of memory accesses, although performing OBMC performance processes of the first sub-block and the second sub-block at once rather than separately, resulting in the same result. That is, the OBMC may be performed by comparing a motion difference between motion information of each sub-block of the current block and motion information of a neighboring block of each sub-block and grouping sub-blocks having the same motion difference into one sub-block. When the neighboring block of the first sub-block is encoded in an intra mode or the neighboring block of the first sub-block is not available, the decoder may perform the step S830 again on another sub-block (e.g., second sub-block) without performing the OBMC on the first sub-block. In addition, when the motion information of each sub-block of the current block is the same as the motion information of the neighboring block of each sub-block, the decoder may not perform the OBMC on a sub-block having the same motion information. That is, when the motion information of the first sub-block and the motion information of the neighboring block of the first sub-block are the same, the decoder may perform the step S830 again on the other sub-block without performing the OBMC on the first sub-block. In this case, the step S830 may be performed first on sub-blocks including the upper boundary of the current block and then performed on sub-blocks including the left boundary of the current block. Conversely, the step S830 may be performed first on the sub-blocks including the left boundary of the current block and then performed on the sub-blocks including the upper boundary of the current block. In this case, the step S830 may be performed starting from a sub-block on the left side with respect to the sub-blocks including the upper boundary. The step S830 may be performed starting from a sub-block on the upper side with respect to the sub-blocks including the left boundary.

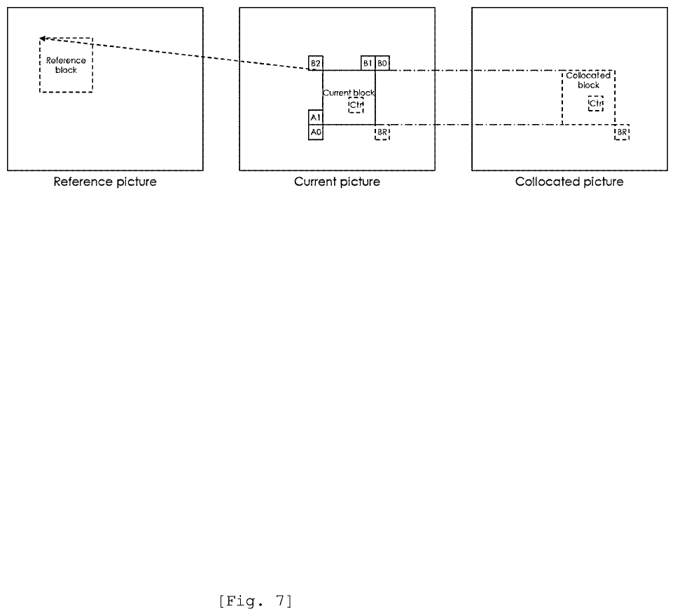

FIG. 9 illustrates a method of performing OMBC in the unit of a CU according to an embodiment of the present disclosure.

Specifically, FIG. 9 illustrates the step S830 in more detail.

Referring to FIG. 9, the decoder may perform the OBMC on an A0 block which is an upper left block of the current block (Case 1). The decoder may perform the OBMC for the A0 block when motion information of the A0 block and motion information of an Ne-A0 block, which is an upper end block adjacent to the A0 block, are different from each other. In this case, in order to perform the OBMC, the decoder may acquire a first prediction block ref A0 from reference picture 0 by using the motion information of the A0 block, and acquire a second prediction block from reference picture 0 by projecting the motion information of the Ne-A0 block onto a location of the A0 block. Further, the decoder may acquire a final prediction block for the A0 block by performing weight-averaging of the first prediction block and the second prediction block, based on a preconfigured weight.

In addition, the decoder may perform the OBMC on an L2 block which is a left block of the current block (Case 2). The decoder may perform the OBMC for the L2 block when motion information of the L2 block and motion information of an Ne-L2 block, which is a left block adjacent to the L2 block, are different from each other. In this case, in order to perform the OBMC, the decoder may acquire a first prediction block ref L2 from reference picture 0 by using the motion information of the L2 block, and acquire a second prediction block of the Ne-L2 block from reference picture 1 by projecting the motion information of the Ne-L2 block onto a location of the L2 block. Further, the decoder may acquire a final prediction block for the L2 block by performing weight-averaging of the first prediction block and the second prediction block, based on a preconfigured weight.

In this case, the preconfigured weight may be defined in a table form. The reference pictures between the current block and the neighboring blocks may be the same as in case 1 or different from each other as in case 2.

Referring to FIG. 9, there may be two blocks (an Ne-A0 block and an Ne-L0 block) adjacent to an A0 (or L0) block which is a sub-block located at an upper left end of the current block. Therefore, the decoder may perform the OBMC two times on the A0 block. For example, the decoder may compare motion information of the A0 block with motion information of the Ne-A0 block and, when the pieces of motion information are different from each other, perform primary OBMC for the A0 block. Afterwards, the decoder may compare the motion information of the A0 block with motion information of the Ne-L0 block, and when the pieces of motion information are different from each other, additionally perform secondary OBMC for the A0 block on which the primary OBMC has been performed. That is, the decoder may acquire a prediction block acquired by performing primary OBMC, and acquire a final prediction block for the A0 block by performing secondary OBMC on the prediction block acquired by performing the primary OMBC, and two times of OBMCs may be performed continuously (or sequentially) on the A0 block. Therefore, the primary OBMC may affect the secondary OBMC. That is, there is a dependency between the primary OBMC and the secondary OBMC. In order to remove the dependency, the decoder may perform the OBMC in parallel when multiple neighboring blocks adjacent to a sub-block exist. For example, the decoder may acquire in parallel a prediction block based on the motion information of the A0 block and the motion information of the Ne-A0 block, and a prediction block based on the motion information of the A0 block and the motion information of the Ne-L0 block. Afterwards, the decoder may acquire a final prediction block for the A0 block by performing weight-averaging of the prediction blocks acquired in parallel. When multiple neighboring blocks adjacent to a sub-block exist, the decoder may perform the OBMC, based on motion information of one neighboring block. For example, the decoder may acquire a first motion difference which is a difference between the motion information of the A0 block and the motion information of the Ne-A0 block, and a second motion difference which is a difference between the motion information of the A0 block and the motion information of the Ne-L0 block. Further, the decoder may compare the first motion difference and the second motion difference to perform the OBMC for the A0 block by using motion information of a neighboring block corresponding to the larger motion difference. For example, if the first motion difference is greater than the second motion difference, the decoder may perform only the OBMC for an upper boundary of the A0 block by using the motion information of the Ne-A0 block which is a neighboring block corresponding to the first motion difference.

FIG. 10 illustrates a method of performing OBMC in the unit of a sub-block according to an embodiment of the present disclosure.

Specifically, FIG. 10 illustrates the step S840 in more detail.

The OBMC in the unit of a CU in the present disclosure may refer to OBMC for sub-blocks adjacent to a current CU boundary, and may be described as CU boundary sub-block OBMC. OBMC in the unit of a sub-block may refer to OBMC for sub-blocks (sub-blocks not adjacent to the CU boundary) within a current CU, and may be described as CU internal sub-block OBMC.

In this case, since a reference picture of the current block is used to perform OBMC, all reference pictures in the unit of a sub-block may be the same.

The decoder may compare motion information of a current sub-block with motion information of each of neighboring blocks adjacent to the upper, lower, left, and right sides of the current sub-block. Further, the decoder may perform OBMC for the current sub-block by using motion information about adjacent neighboring blocks which have motion information different from the motion information of the current sub-block.

A method of performing OBMC for a luminance component sub-block will be described with reference to FIG. 10. The current sub-block is a luminance component sub-block, and the motion information of the current sub-block may be different from the motion information of each of the neighboring blocks adjacent to the upper, lower, left, and right sides of the current sub-block. In this case, the decoder may generate each prediction block by projecting the motion information about each of the neighboring blocks onto the current sub-block. That is, referring to FIG. 10, a prediction block generated based on the motion information about the neighboring block adjacent to the upper side of the current sub-block may be an Ref.A block, a prediction block generated based on the motion information about the neighboring block adjacent to the lower side of the current sub-block may be an Ref.B block, a prediction block generated based on the motion information about the neighboring block adjacent to the left side of the current sub-block may be an Ref. L block, and a prediction block generated based on the motion information about the neighboring block adjacent to the right side of the current sub-block may be an Ref.R block. The decoder may acquire a prediction block for the current sub-block by performing weight-averaging of the Ref.A block, the Ref. B block, the Ref. L block, and the Ref.R block. In this case, since multiple prediction blocks are added, the decoder may perform weight-averaging by using an expanded pixel range and then reconstruct the pixel range to the existing pixel range. A difference value obtained by subtracting the sum of weights according to each pixel location of the upper, lower, left, and right neighboring blocks from the total weight of the expanded pixel range may be a weight for each pixel of a current prediction block. When a neighboring block of the current sub-block is encoded in an intra mode, a weight of the corresponding neighboring block may be configured to be 0. In addition, when the neighboring block of the current sub-block is not available, a weight of the neighboring block which is not available may be configured to be 0. In addition, when the expanded pixel range is used, a video signal processing device (e.g., an encoder or a decoder) may fall outside the range of acceptable values. Therefore, weight average calculation may be applied by reducing a pixel value of each prediction block to a range of predetermined values. As a method of reducing a pixel value to a range of predetermined values, a method of performing a predetermined number of “>>” which refers to a right shift operation on each pixel value of a prediction block may be used. In this case, the predetermined number may be an integer greater than or equal to 1 and may be 2. In order to reconstruct an original range after the weight-averaging is performed, a method of performing a predetermined number of “<<” which refers to a left shift operation may be used, and the predetermined number may be equal to a number by which the range of values is reduced.

A method of performing OBMC for a chrominance component sub-block will be described with reference to FIG. 10. For example, when a component format of a current picture is 4:2:0, the horizontal and vertical sizes of a chrominance component block are half of the horizontal and vertical sizes of a luminance component block. That is, if the size of the luminance component block is 4×4, the size of the chrominance component block is 2×2. Therefore, only 2×2 value may exist in a weight table. A method of performing OBMC on a chrominance component sub-block may be similar to a method of performing OBMC for a luminance component sub-block. However, the resolution of motion information of a chrominance component sub-block may be half of the resolution of motion information of a luminance component sub-block. That is, there may be a difference between the motion information of the luminance component sub-block and motion information of a neighboring block of the luminance component sub-block, but there may be no difference between the motion information of the chrominance component sub-block and motion information of a neighboring block of the chrominance component sub-block. In this case, OBMC may be applied only to the luminance component sub-block, and the OBMC may not be applied to the chrominance component sub-block. Therefore, a blocking phenomenon which has not occurred in the luminance component sub-block may occur in the chrominance component sub-block. If OBMC is applied to the luminance component sub-block to solve the blocking phenomenon, the OBMC may also be applied to the chrominance component sub-block. The OBMC in the unit of a CU may be performed for each of Y, U, and V components, and in the case of the chrominance component block, the OBMC may be performed on the first adjacent pixel line. In this case, it is natural that the present invention is not limited to the first pixel line.

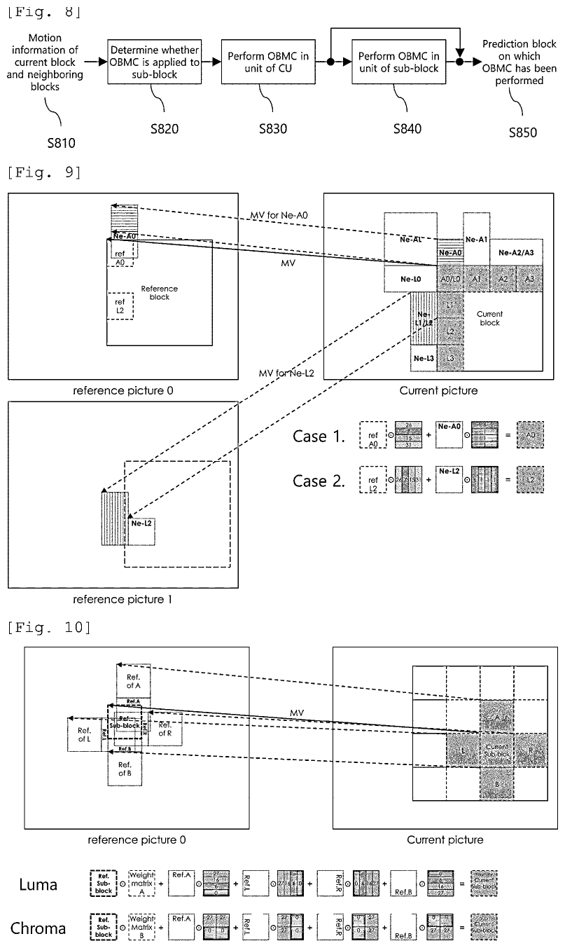

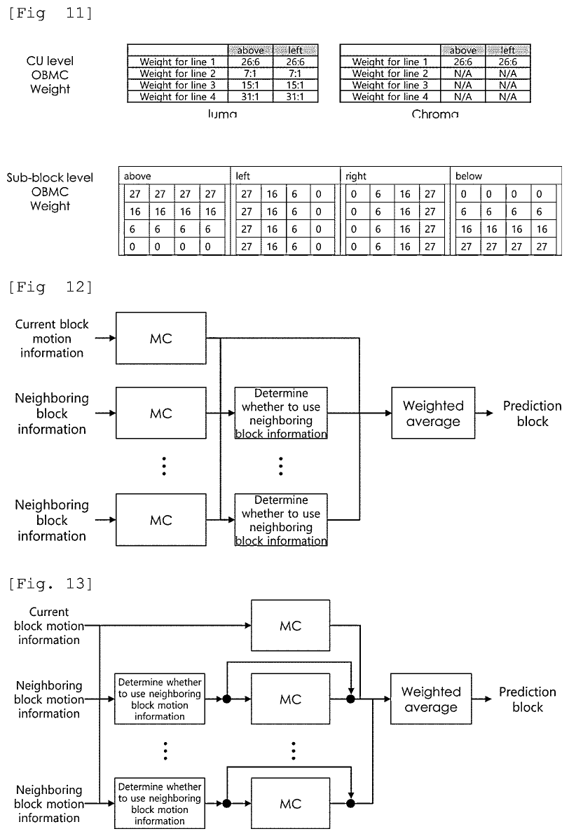

FIG. 11 illustrates a table in which a weight is defined according to an embodiment of the present disclosure.

A weight in the present disclosure may be determined based on a location of an adjacent block and a color component (whether it is a luminance component or a chrominance component) of a current block. For example, when OBMC in the unit of a CU is performed, a current sub-block is a block including an upper boundary of the current block, and in the case of a luminance component block, a weight for a prediction block of the current sub-block may be configured to increase from the upper side to the lower side (referring to Case 1 in FIG. 9). In addition, when the OBMC in the unit of a CU is performed, the current sub-block is a block including a left boundary of the current block, and in the case of the luminance component block, the weight for the prediction block of the current sub-block may be configured to increase from the left side to the right side (referring to Case 2 in FIG. 9).

In addition, the weight in the present disclosure may be determined depending on whether a neighboring block of the current block (the sub-block of the current block) is a block for which reconstruction has been completed or a block on which only prediction has been performed. For example, when the neighboring block is the block on which reconstruction has been completed, a strong blocking phenomenon may occur, and thus filtering based on a high weight may be performed. That is, a weight for a portion of the neighboring block adjacent to the boundary of the current block may be configured to be higher than a weight for a prediction block of the current block. Conversely, since a boundary portion may be the characteristic of an image itself, the for weight the portion of the neighboring block adjacent to the boundary of the current block may be configured to be smaller than the weight for the prediction block of the current block. The decoder may identify whether the boundary portion is the characteristic of the image itself, through quantization parameter information of the current block and distribution of pixels around the boundary. When the boundary portion is the characteristic of the image itself, the decoder may apply the existing deblocking filtering method.

OBMC in the unit of a sub-block may be performed according to a predetermined block size (unit). For example, the decoder may perform OBMC on a sub-block having a 4×4 size. However, the units of sub-blocks for an affine mode, an sbTMVP mode, and an MP-DMVR mode may be different from each other. For example, the affine mode is processed in the unit of a 4×4 sub-block, the sbTMVP mode is processed in the unit of a 8×8 sub-block, the MP-DMVR mode is processed in the units of 8×8, 8×4, 4×8, and 4×4 sub-blocks, and thus motion information may be different for each unit. The OBMC has an effect of alleviating a blocking phenomenon at a block boundary caused by a motion difference between motion information of the current block and motion information of the neighboring block of the current block, and thus a sub-block unit for the OBMC is needed to be changed depending on each encoding mode. As an embodiment, since the sbTMVP mode has different pieces of motion information in the unit of an 8×8 sub-block, when the current block is encoded in the sbTMVP mode, the unit of a sub-block for sub-block OBMC processing may be 8×8. As another embodiment, since the MP-DMVR mode has different pieces of motion information in the unit of 8×8, 8×4, 4×8, and 4×4 sub-blocks, when the current block is encoded in the MP-DMVR mode, the unit of a sub-block for sub-block OBMC processing may be configured to be the same as the MP-DMVR processing unit.

The OBMC may be applied only when the motion information of the current block corresponds to unidirectional prediction. The OBMC may not be performed when there is no difference between the motion information of the current block and the motion information of the neighboring block of the current block. This may be to increase a bidirectional prediction effect through various motion information. That is, the decoder may selectively use a neighboring block, use motion information about multiple neighboring blocks, or use scaled motion information about another reference picture so that the decoder applies various motion information when performing the OBMC.

When the OBMC is performed, the decoder may selectively use a neighboring block of the current block. For example, when the OBMC for the A0 block of FIG. 9 is performed, the decoder may additionally use motion information of an Ne-AL block and an Ne-A1 block in addition to the motion information of the Ne-A0 block. The decoder may additionally use motion information about a block adjacent to the neighboring block of the current block.

The decoder may perform the OBMC by using another reference picture. For example, when the OBMC for the L2 block of FIG. 9 is performed, the decoder may use motion information of an Ne-L2 block scaled by reference picture 0 in addition to a reference block of reference picture 1. That is, the decoder may acquire a prediction block for the L2 block by performing weight-averaging of three prediction blocks (a prediction block acquired based on the motion information of the L2 block, a prediction block acquired based on the motion information of the Ne-L2 block, and a prediction block acquired based on the motion information of the scaled Ne-L2 block). In addition, the decoder may acquire a prediction block for the L2 block by performing weight-averaging of two prediction blocks (a prediction acquired based on the motion information of the L2 block, and a prediction block acquired based on the scaled Ne-L2 block). In addition, the decoder may perform the OBMC by using only a reference picture used by the motion information of the L2 block. In this case, since there is only one reference picture, memory usage can be reduced.

An OBMC method may reduce a blocking phenomenon between blocks, but has a problem that afterimages such as a halo phenomenon may occur when the characteristic of the neighboring block of the current block is different from that of the current block. Since the halo phenomenon may occur due to different motions between different objects, the OBMC is not applied uniformly to all blocks, but application of the OBMC may be determined depending on the characteristic between neighboring blocks.

FIGS. 12 to 14 illustrate a method of selectively using a neighboring block when performing OBMC according to an embodiment of the present disclosure. MC in FIGS. 12 to 14 may refer to motion compensation.

Referring to FIG. 12, when OBMC is performed on a current block, the decoder may selectively use prediction blocks of neighboring blocks of the current block or apply different weights. The decoder may generate a prediction block for each of the neighboring blocks through motion information of the neighboring blocks of the current block, and then determine whether to use a corresponding neighboring block to acquire a final prediction block of the current block, based on the motion information of the neighboring blocks. Specifically, the decoder may use, for a weight average, only prediction blocks, which satisfy a specific condition, without using, for a weight average, all prediction blocks for each of the neighboring blocks generated to acquire the final prediction block of the current block. In this case, the specific condition may be a case where a cost between a prediction block acquired based on motion information of the current block and prediction blocks acquired based on the motion information of the neighboring blocks of the current block is within a predetermined value. That is, the decoder may use, for a weight average, only prediction blocks of neighboring blocks corresponding to the cost within the predetermined value. Alternatively, the decoder may configure a higher weight for a prediction block (a main prediction block) of a neighboring block corresponding to the cost within the predetermined value compared to other neighboring blocks, and configure a lower weight than that of the main prediction block for other neighboring blocks. In this case, the predetermined value may be the size of the current block (the horizontal size of the current block or the vertical size of the current block) or the number of pixels of the current block, and the cost may be a pixel-based cost. That is, the decoder may determine a neighboring block to be used for the OBMC, based on a similarity between the current block and the neighboring blocks of the current block.

Referring to FIG. 13, when the OBMC is performed on the current block, the decoder may consider the characteristic of the motion information of the neighboring blocks of the current block. The decoder may determine whether to acquire prediction blocks of the neighboring blocks or a weight to be configured, through the characteristic of the neighboring blocks of the current block. The decoder may compare a motion difference between the motion information of the current block and the motion information of the neighboring blocks, and when the motion difference is within (or equal to or greater than) a predetermined value, acquire a prediction block of a corresponding neighboring block, based on the motion information of the neighboring block. Further, the decoder may acquire a final prediction block for the current block by performing weight-averaging of the acquired prediction block and the prediction block of the current block. In this case, the predetermined value is a value which is changed depending on motion resolution information of the current block, and may be a positive integer.

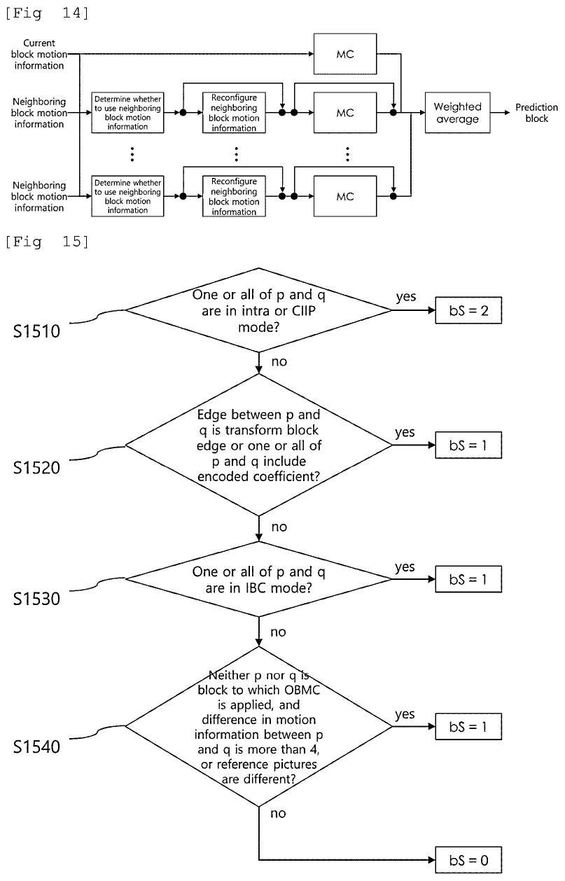

Referring to FIG. 14, when the OBMC is performed on the current block, the decoder may reconfigure motion information in consideration of the characteristic of the motion information of the neighboring blocks of the current block. As described above through FIG. 13, the decoder may compare a motion difference between the motion information of the current block and the motion information of the neighboring blocks, and when the motion difference is within (or equal to or greater than) a predetermined value, acquire a prediction block of a corresponding neighboring block, based on the motion information of the neighboring block. In this case, if the motion information difference between the neighboring blocks and the current block is not within (or equal to or greater than) the predetermined value, the decoder may reconfigure the corresponding motion information as new motion information. In this case, the new motion information may be reconfigured by using motion information adjacent to the neighboring blocks or motion information of temporal neighboring blocks located at the same location in a corresponding picture. For example, after separating the motion information of the neighboring blocks into motion information in horizontal and vertical directions, a middle value of the motion information in the horizontal direction and a middle value of the motion information in the vertical direction may become new motion information. The decoder may acquire a final prediction block for the current block by performing weight-averaging of a prediction block acquired based on the motion information of the current block, prediction blocks acquired based on the existing motion information of the neighboring blocks, and prediction blocks acquired based on the new motion information. The existing motion information of the neighboring blocks may be motion information of a neighboring block for which the above-described motion information difference is within (or equal to or greater than) a predetermined value. In this case, the predetermined value is a value which is changed depending on motion resolution information of the current block, and may be a positive integer.

In addition, when the neighboring blocks of the current block are not available or the neighboring blocks are encoded in an intra mode, the decoder may derive new replacement motion information and use the same to generate a prediction block. That is, the decoder may derive TMVP motion information about a current sub-block in advance, and then, when at least one unavailable neighboring block occurs, generate a prediction sub-block by using TMVP motion and apply weight-based OBMC. The new replacement motion information may be reconfigured by using motion information adjacent to the neighboring blocks or motion information of temporal neighboring blocks located at the same location in a corresponding picture. For example, the decoder may separate the motion information of the neighboring blocks into motion information in horizontal and vertical directions, and then reconfigure a middle value of the motion information in the horizontal direction and a middle value of the motion information in the vertical direction as new motion information.

FIG. 15 illustrates a method of determining a strength of deblocking filtering when performing OBMC, according to an embodiment of the present disclosure.

p and q in FIG. 15 may be a p block including a p pixel at a first location and a q block including a q pixel at a second location. The p block and the q block may be blocks on which deblocking filtering is performed. For example, when deblocking filtering is performed on a boundary between sub-blocks of a coding block, the p block and the q block may be sub-blocks of the coding block including the boundary. In addition, when deblocking filtering is performed on the boundary between the sub-blocks of the coding block and neighboring blocks of the coding block, the p block may be a neighboring block of the coding block, and the q block may be a sub-block (a sub-block including the boundary of the coding block) of the coding block.

Referring to FIG. 15, the decoder may identify whether an encoding mode for at least one block among the p block and the q block is an intra mode or a CIIP mode (S1510). As a result of the step S1510, when the encoding mode for at least one block is the intra mode or the CIIP mode, the decoder may configure a bS value indicating a filtering strength for a current block to be 2. As a result of the step S1510, when the encoding mode for at least one block is not the intra mode and the CIIP mode, the decoder may identify whether an edge between the p block and the q block is a transform block edge or whether at least one of the p block and the q block includes an encoded coefficient (S1520). As a result of the step S1520, when the edge between the p block and the q block is the transform block edge or at least one of the p block and the q block includes the encoded coefficient, the decoder may configure the bS value to be 1. As a result of the step S1520, when the edge between the p block and the q block is not the transform block edge, and at least one of the p block and the q block does not include the encoded coefficient, the decoder may identify whether an IBC mode is applied to at least one block among the p block and the q block (S1530). As a result of the step S1530, when the IBC mode is applied to the at least one block, the decoder may configure the bS value to be 1. As a result of the step S1530, when the IBC mode is not applied to the at least one block, the decoder may identify whether neither the p block nor the q block is a block to which OBMC is applied, and a difference between motion information of the p block and motion information of the q block is 4 or more, or a reference picture of the p block and a reference picture of the q block are different from each other (S1540). As a result of the step S1540, when neither the p block nor the q block is the block to which the OBMC is applied, and the difference between the motion information of the p block and the motion information of the q block is 4 or more, or the reference picture of the p block and the reference picture of the q block are different from each other, the decoder may configure the bS value to be 1. As a result of the step S1540, when at least one of the p block and the q block is the block to which the OBMC is applied, and the difference between the motion information of the p block and the motion information of the q block is 4 or more, or the reference picture of the p block and the reference picture of the q block are not different from each other, the decoder may configure the bS value to be 0. The larger the bS value, the greater the strength of deblocking filtering. If the bS value is “2”, strong filtering may be performed, if the bS value is “1”, weak filtering may be performed, and if the bS value is “0”, filtering may not be performed. In addition, strong filtering may change more than a predetermined number of pixel values around a boundary between the p block and the q block through filtering, and weak filtering may change pixel values less than the predetermined number. The predetermined number may be an integer and may be 6. That is, the decoder may not perform deblocking filtering on a boundary of the current block if the OBMC has been performed on at least one block among neighboring blocks of the current block. This is because the OBMC method has an effect of alleviating a blocking phenomenon caused by a motion difference between blocks.

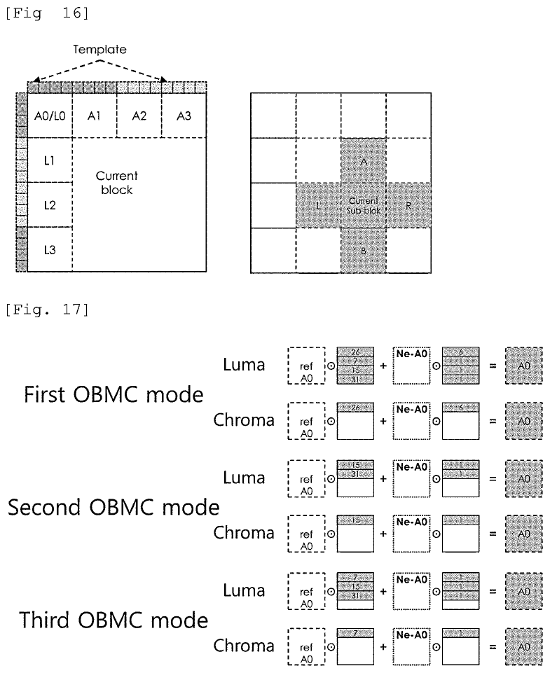

FIG. 16 illustrates a method of configuring a template for performing OBMC, according to an embodiment of the present disclosure.

Referring to FIG. 16, the decoder may determine whether to perform (apply) OBMC to a current block (coding block) based on a template. Hereinafter, a method of configuring a template by using neighboring blocks (pixels) adjacent to a current block according to an embodiment of the present disclosure will be described.

Whether to perform OBMC may be determined in the unit of a coding block, and an encoder may generate a bitstream including information related to whether to perform the OBMC. The decoder may parse a bitstream to determine whether the OBMC is performed on the current block. When the OBMC is applied to the current block, the OBMC may be applied to all sub-blocks (A0/L0, A1, A2, A3, L1, L2, and L3 blocks in FIG. 16) including a boundary of the current block. In this case, since each sub-block has a different characteristic, the decoder may determine whether the OBMC is applied to each sub-block.

Since the OBMC method uses motion information of a neighboring block of the current block, the decoder may determine whether to perform the OBMC on the current block (each sub-block of the current block), based on the similarity between the current block and the neighboring block of the current block. In addition, the decoder may determine the weight and the length of filtering for the OBMC applied to each sub-block, based on the similarity between the current block and the neighboring block of the current block. Specifically, the decoder may determine whether to perform OBMC for each sub-block, and the weight and the length of filtering for the OBMC, based on at least one of a difference between motion information of the current block and the motion information of the neighboring block of the current block, motion resolution information of the current block, motion resolution information of the neighboring block of the current block, prediction direction information (e.g., L0 prediction, L1 prediction, and bidirectional prediction) of the current block, the horizontal length of the current block, the vertical length of the current block, the product of the horizontal and vertical lengths of the current block, and an encoding mode (e.g., a merge mode, an affine mode, an sbTMVP mode, etc.) of the current block.

In this case, the weight and the length of filtering for the OBMC may also be applied to a prediction sample. The weight and the length of filtering applied to a sample predicted through motion information of a current sub-block may be the same as or different from the weight and the length of filtering applied to a sample predicted through motion information of a block adjacent to the current sub-block. For example, the OBMC may be performed on a neighboring block at the upper (or left) side of the current block. In this case, when the length of filtering applied to the sample predicted through the motion information of the current sub-block is 3 pixel lines (or 3 pixel columns), the length of filtering applied to the sample predicted through the motion information of the block adjacent to the upper (or left) side of the current sub-block may also be configured to be 3 pixel lines (or 3 pixel columns). In this case, when the length of OBMC filtering applied to the sample predicted through the motion information of the current sub-block is 3 pixel lines, a weight for each pixel line (or a weight for each pixel column) may be configured to be “7, 15, 31”. In addition, the length of OBMC filtering applied to the sample predicted through the motion information of the block adjacent to the upper (or left) side of the current sub-block may be configured to be 3 pixel lines (or 3 pixel columns), and a weight for each pixel line (or a weight for each pixel column) may be configured to be “1, 1, 1”.

Referring to FIG. 16, the decoder may determine whether the OBMC is performed on the current block, based on a template. First, the decoder may configure a template including pixels of a reconstructed block adjacent to the current block, and for convenience of description, this template may be referred to as a reference template. The width of an upper template may be determined based on the horizontal size of each sub-block, and the height of the upper template may be a preconfigured size. The height of a left template may be determined based on the vertical size of each sub-block, and the width of the left template may be a preconfigured size. The preconfigured size is a natural number and may be 1. In this case, the upper template for each sub-block may vary based on the size of a sub-block, and when the size of the sub-block is 4×4, the size of the upper template may be 4×1. Next, the decoder may calculate three costs for each sub-block. A first cost (Cost 1) may be obtained based on the motion information of the current sub-block, a second cost (Cost 2) may be obtained based on the motion information of the block adjacent to the current sub-block, and a third cost (Cost 3) may be obtained based on the motion information of the current sub-block and the motion information of the block adjacent to the current sub-block. The cost described in the present disclosure may be obtained through pixel-unit sum of absolute differences (SAD) or mean-removed SAD (MRSAD) calculation between samples obtained by predicting an area corresponding to a template by using motion information of each sub-block and the template. Specifically, the first cost may be obtained based on a template (reference template) including pixels of a reconstructed block adjacent to the current sub-block and a first reference template predicted by projecting the motion information of the current sub-block onto the reference template. The second cost may be obtained based on the reference template and a second reference template predicted by projecting motion information of a block adjacent to the current sub-block onto the reference template. The third cost may be obtained based on the first reference template and the second reference template. Alternatively, the third cost may be obtained based on the reference template and a prediction sample obtained by performing weight-averaging of a sample obtained by predicting an area corresponding to a template by using the motion information of the current sub-block and a sample obtained by predicting an area corresponding to a template by using the motion information of the block adjacent to the current sub-block. In this case, a weight is a preconfigured value and may be a decimal value of 0 or more. For example, the preconfigured value may be ¼, ¾, etc. Next, the decoder may derive whether to perform OBMC for the current sub-block, the length of filtering for the OBMC, and the weight, based on the obtained cost. For example, if Cost 1 (first cost) is the smallest among the obtained costs, the OBMC may not be performed on a corresponding sub-block. In addition, if Cost 1 is the smallest among the obtained costs, a second OBMC mode may be performed on a corresponding sub-block, or a new OBMC mode having a filtering length smaller than the filtering length for the second OBMC mode may be performed. In addition, if a value of “(Cost 2+(Cost 2>2)+(Cost 2>>3))” is less than or equal to Cost 1, a first OBMC mode may be performed on a corresponding sub-block. Herein, “X>>Y” refers to a right shift operation, and a quotient obtained by dividing X by 2 as many times as Y may be output. If Cost 1 is less than or equal to Cost 2, the second OBMC mode may be performed on a corresponding sub-block. Conversely, if Cost 1 is greater than Cost 2, a third OBMC mode may be performed on a corresponding sub-block.

FIG. 17 illustrates a method of generating prediction block according to each OBMC mode according to an embodiment of the present disclosure.

The first OBMC mode, the second OBMC mode, and the third OBMC mode described in the present disclosure will be described with reference to FIG. 17.

An ref A0 block and an Ne-A0 block in FIG. 17 may be blocks having a 4×4 size. The ref A0 in FIG. 17 may be a current sub-block and may be the same as the ref A0 block in FIG. 9. The Ne-A0 block in FIG. 17 is a neighboring block adjacent to the upper side of a current sub-block and may be the same as the Ne-A0 block in FIG. 9. Referring to FIG. 17, numbers shown next to the ref A0 block and the Ne-A0 block may indicate a weight and a length of OBMC filtering. The decoder may perform weight-averaging of a prediction block ref A0 and the Ne-A0 block to acquire a current sub-block A0 to which OBMC filtering is applied. The first OBMC mode, the second OBMC mode, and the third OBMC mode may be applied to each of a luminance component block and a chrominance component block. When the first OBMC mode is applied to the luminance component block, the first OBMC mode may be a mode in which a current luminance component sub-block is obtained by performing weight-averaging of 4 pixel lines of the current luminance component sub-block and 4 pixel lines of a luminance component block adjacent to the upper side of the current sub-block. When the second OBMC mode is applied to the luminance component block, the second OBMC mode may be a mode in which a current luminance component sub-block is obtained by performing weight-averaging of 2 pixel lines of the current luminance component sub-block and 2 pixel lines of a luminance component block adjacent to the upper side of the current sub-block. When the third OBMC mode is applied to the luminance component block, the third OBMC mode may be a mode in which a current luminance component sub-block is obtained by performing weight-averaging of 3 pixel lines of the current luminance component sub-block and 3 pixel lines of a luminance component block adjacent to the upper side of the current sub-block. When the first OBMC mode, the second OBMC mode, and the third OBMC mode are applied to the chrominance component block, the first OBMC mode, the second OBMC mode, and the third OBMC mode may be modes in which a current chrominance component sub-block is obtained by performing weight-averaging of 1 pixel line of the current chrominance component sub-block and 1 pixel line of a chrominance component block adjacent to the upper side of the current sub-block. For example, when the first OBMC mode is applied to the luminance component block, 4 pixels of the first pixel line of the luminance component block of the ref A0 block are multiplied by a weight of “26”, 4 pixels of the second pixel line are multiplied by a weight of “7”, 4 pixels of the third pixel line are multiplied by a weight of “15”, and 4 pixels of the fourth pixel line are multiplied by a weight of “31”, so that a weighted “ref A0” luminance component prediction block may be generated. In addition, 4 pixels of the first pixel line of the Ne-A0 block are multiplied by a weight of “6”, 4 pixels of the second pixel line are multiplied by a weight of “1”, 4 pixels of the third pixel line are multiplied by a weight of “1”, and 4 pixels of the fourth pixel line are multiplied by a weight of “1”, so that a weighted “Ne-A0” luminance component prediction block may be generated. The decoder may generate a final prediction block for A0 by performing weight-averaging of a weighted “ref A0” prediction block and a weighted “Ne-A0” prediction block. The decoder may apply the second OBMC mode and the third OBMC mode in the same method to generate a final prediction block for A0.

Whether to perform template-based OBMC may be determined based on the cost obtained by using motion information of the current sub-block and motion information of a neighboring block of the current sub-block. In addition, as described above with reference to FIG. 16, the template-based OBMC may be performed on only a sub-block which includes a boundary of a current block. The decoder may determine whether to apply OBMC for each sub-block unit. The template-based OBMC may not be applied to a sub-block which does not include the boundary of the current block. When the OBMC is applied to at least one sub-block among sub-blocks which include the boundary of the current block, the OBMC may also be applied to a sub-block which does not include the boundary of the current block. In addition, when an encoding mode of the current block is one of an affine mode, a DMVR (or multi-pass DMVR) mode, a TM Merge mode, an MMVD mode, an affine MMVD mode, a BM merge mode, and a GPM mode, the OBMC may be applied to a sub-block which does not include the boundary of the current block.

Whether the OBMC is applied to the current block may be determined by comparing the image quality and bit amount when the OBMC is applied to the current block with the image quality and bit amount when the OBMC is not applied to the current block. That is, by comparing the image quality and bit amount when the OBMC is applied to the current block with the image quality and bit amount when the OBMC is not applied to the current block, if a compression efficiency is good when the OBMC is applied to the current block, the OBMC may be applied, and if the compression efficiency is not good, the OBMC may not be applied. The encoder may generate a bitstream which includes information (e.g., a syntax element) about whether the OBMC is applied to the current block. The decoder may determine whether to apply the OBMC to the current block by parsing the information about whether the OBMC is applied to the current block from the bitstream. When the OBMC is applied to the current block as a result of the parsing, the decoder may divide the current block into multiple sub-blocks and then perform the template-based OBMC for each sub-block. In this case, whether the OBMC is performed for each sub-block may be determined. When the OBMC is not applied to the current block as a result of the parsing, the template-based OBMC may not be performed on all sub-blocks of the current block.

FIGS. 18 to 20 illustrate a process of performing OBMC according to an embodiment of the present disclosure.

Referring to FIG. 18, the decoder may parse a bitstream to identify whether OBMC is applied to a current block. When the OBMC is applied to the current block, the decoder may divide the current block into multiple sub-blocks. In this case, different OBMCs may be applied to sub-blocks (boundary sub-blocks) which include a boundary of the current block and sub-blocks (internal sub-blocks) which do not include the boundary of the current block, respectively. First, the decoder may determine whether OBMC is applied to a sub-block including the boundary of the current block and an OBMC mode to be applied, based on a template. When the OBMC is applied to the sub-block including the boundary of the current block, the decoder may perform filtering on the corresponding sub-block according to the determined OBMC mode. Further, when the OBMC has been applied to all sub-blocks including the boundary of the current block, the decoder may identify whether the OBMC is applied to a sub-block which does not include the boundary of the current block. In this case, whether the OBMC is applied to the sub-block which does not include the boundary of the current block may be determined based on an encoding mode of the current block. Specifically, when the current block is encoded in one of Affine, DMVR, TM Merge, MMVD, affine MMVD, BM merge, AMVP-merge, and GPM modes, the OBMC may be performed on the sub-block which does not include the boundary of the current block. When the OBMC is performed on the sub-block which does not include the boundary of the current block, the decoder may perform OBMC filtering on the corresponding sub-block. Further, the decoder may perform OBMC filtering on all sub-blocks which do not include the boundary of the current block. The decoder may perform OBMC filtering on the all sub-blocks which do not include the boundary of the current block, so as to generate a prediction block to which OBMC filtering is applied.

The decoder may primarily determine whether OBMC is applied to the current block from a bitstream, and then secondarily determine whether the OBMC is applied, based on a template for each sub-block of the current block. When information about whether the OBMC is applied to the current block is included in the bitstream and signaled, there may be a problem that a bit amount increases. Therefore, the bitstream does not include the information about whether the OBMC is applied to the current block, and the decoder may reduce a bit amount by determining whether the OBMC is performed for each sub-block, based on the template.

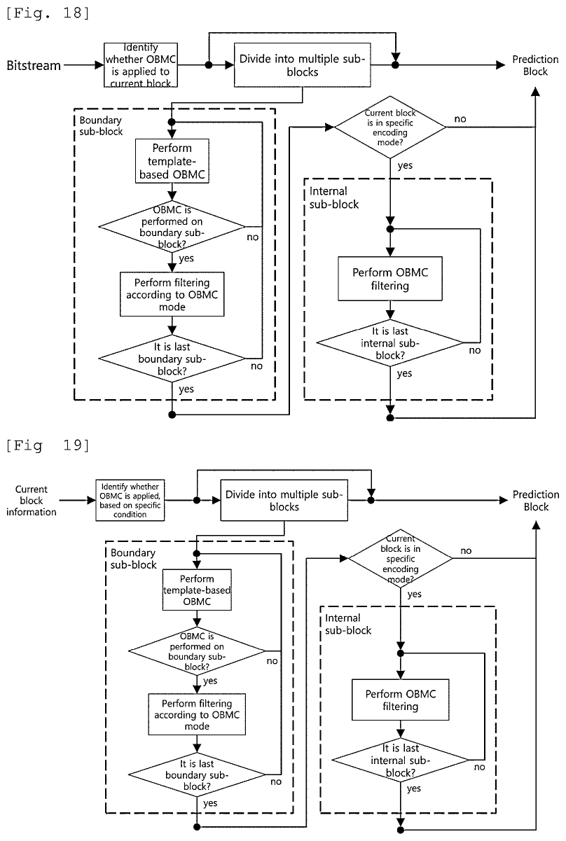

Hereinafter, with reference to FIG. 19, a method will be described in which a bitstream does not include information about whether OBMC is applied to a current block and the decoder determines whether OBMC is performed for each sub-block, based on a template.

Referring to FIG. 19, the decoder may acquire information about a current block and identify whether OBMC is applied to the current block, based on specific conditions. When the OBMC is applied to the current block, the decoder may divide the current block into multiple sub-blocks and apply the OBMC to each sub-block, and a specific process is the same as the process described with reference to FIG. 18. In this case, the specific conditions are as follows. i) When horizontal and vertical sizes of the current block are smaller than a threshold value, or when the product of the horizontal and vertical sizes of the current block is smaller than the threshold value, OBMC may not be applied to the current block. In this case, the threshold value is a positive integer and may be 8 or 32. ii) When an encoding mode of the current block is one of an intra mode, an IBC mode, a TMP mode, an LIC mode, and a BCW mode, OBMC may not be applied to the current block. iii) When an encoding mode of the current block is one of merge, Affine, DMVR, TM Merge, MMVD, affine MMVD, BM merge, AMVP-merge, and GPM modes, OBMC may be applied to the current block. Whether OBMC is applied to each of the sub-blocks (boundary and internal sub-blocks) of the current block may be determined based on a template.

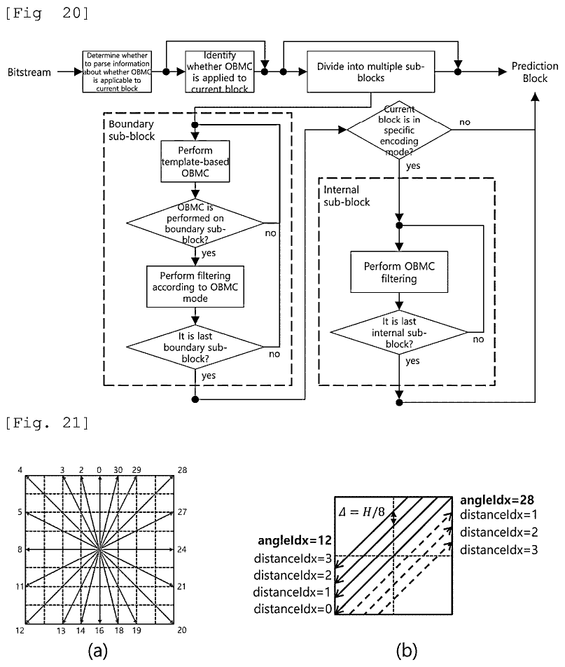

Referring to FIG. 20, the decoder may acquire a bitstream including information about whether OBMC is applicable to a current block. The decoder may determine whether to parse the information about whether the OBMC is applicable to the current block, based on specific conditions. When the OBMC is applicable to the current block as a result of the parsing, the decoder may identify whether the OBMC is applied to the current block. Further, when the OBMC is applied to the current block, the decoder may apply the OBMC to each sub-block of the current block by using the method described with reference to FIG. 18. In this case, the specific conditions are the same as the conditions described above with reference to FIG. 19.

Template-based OBMC may be applied to each of a luminance component block and a chrominance component block. That is, whether the OBMC is applied may be determined for each luminance component block and each chrominance component block. Therefore, in relation to whether the OBMC is applied to a chrominance block, whether the OBMC is applied may be configured for each chrominance sub-block, based on a cost through a chrominance block adjacent to a current chrominance block. Alternatively, when the OBMC is applied to a luminance block through a template-based OBMC method, the OBMC may be configured to be applied to a chrominance block as well.

In addition, the template-based OBMC may be applied to sub-blocks which include a boundary of the current block and sub-blocks which do not include the boundary of the current block. Whether the OBMC is applied to the sub-blocks which do not include the boundary of the current block may be determined depending on the number of sub-blocks to which the OBMC is applied among the sub-blocks which include the boundary of the current block. For example, when the number of sub-blocks to which the OBMC is applied among the sub-blocks including the boundary of the current block is equal to or greater than a predetermined value, the OBMC may be applied to the sub-blocks which do not include the boundary of the current block. Conversely, when the number of sub-blocks to which the OBMC is applied among the sub-blocks including the boundary of the current block is smaller than the predetermined value, the OBMC may not be applied to the sub-blocks which do not include the boundary of the current block. In this case, the predetermined value is a positive integer and may be 4. In addition, when the OBMC is not applied to any one of the sub-blocks including the boundary of the current block, the OBMC may not be applied to the sub-blocks which do not include the boundary of the current block.

FIG. 21 illustrates a GPM mode according to an embodiment of the present disclosure.

Case (a) of FIG. 21 illustrates an angle in a GPM mode, and case (b) of FIG. 21 illustrates a distance in a GPM mode. A GPM mode may be a method in which a current block is divided into two areas (a first area and a second area) based on a reference line and each of the first area and the second area is encoded. Specifically, inter prediction, an intra prediction mode, and intra and inter prediction may all be used for each of the first area and the second area. That is, each of the first area and the second area may be encoded in the intra prediction or inter prediction mode. The first area and the second area may be encoded in the same mode or may be encoded in different modes. For example, when the first area is encoded in the inter mode, OBMC may be applied to the current block based on motion information about the first area.

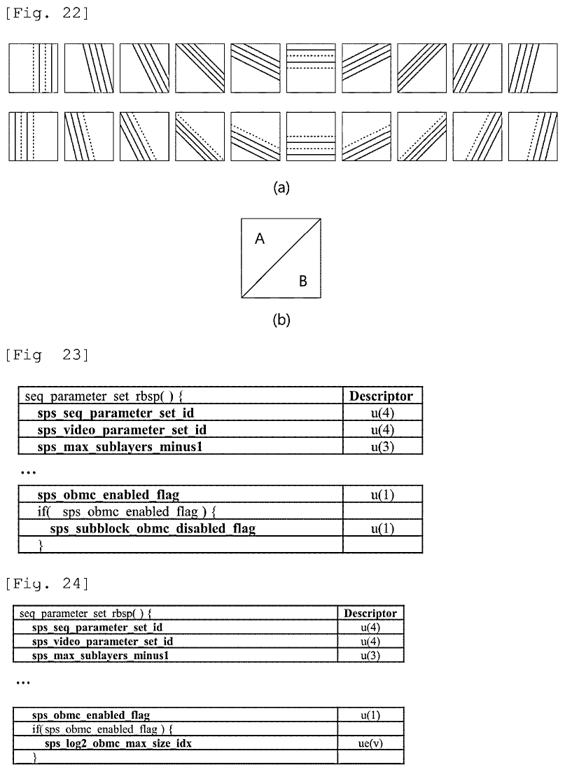

FIG. 22 illustrates a method of dividing a GPM mode according to an embodiment of the present disclosure.

Case (a) of FIG. 22 illustrates various embodiments in which a current block is divided in a GPM mode. The solid line in case (a) of FIG. 22 represents a dividing reference line. The dotted line in case (a) of FIG. 22 represents a reference line which overlaps with that of another dividing method. When the current block is divided, an angle may be the same, but a division form may vary depending on a distance. For example, in the first drawing in case (a) of FIG. 22, the current block may be divided into two areas based on a reference line in a vertical direction (same angle), and there may be four reference lines (dotted line and solid line) depending on a distance. The current block may be divided into two areas based on one reference line among the four reference lines. Case (b) of FIG. 22 illustrates an embodiment of a current block divided according to a GPM mode. Referring to case (b) of FIG. 22, the current block may be divided into area A and area B based on an upper right diagonal line. In this case, neighboring blocks adjacent to the left and upper sides of the area A may be blocks for which reconstruction has been completed. Therefore, OBMC may be applied to the area A based on motion information of the neighboring blocks. On the other hand, neighboring blocks adjacent to the right and lower sides of the area B may be blocks for which reconstruction has not been completed. Therefore, since there is no motion information about the neighboring blocks, the OBMC may not be applied to the area B. When the divided area is adjacent to neighboring blocks adjacent to the left and upper sides of the current block, the OBMC may be applied to the corresponding divided area, and when the divided area is not adjacent to the neighboring blocks adjacent to the left and upper sides of the current block, the OBMC may not be applied to the corresponding divided area. That is, whether to apply the OBMC may be determined depending on a division form and a location of an area according to a GPM mode. In addition, one of the two areas divided according to the GPM mode may be encoded in an intra mode. In this case, the OBMC may not be applied to an area encoded in the intra mode since there is no motion information. In addition, when one of the two areas is encoded in the intra mode, an OBMC process in the unit of a sub-block may not be performed, and syntax related to the OBMC may not be parsed. In the GPM mode, when both the two divided areas are encoded in the intra mode, the OBMC may not be applied since there is no motion information, and syntax (obmc_flag) related to the OBMC may not be parsed. For example, when the GPM mode is applied to the current block and at least one of the two divided areas is encoded in the intra mode, a value of obmc_flag may be inferred to be “0”. If the value of obmc_flag is 0, it may mean that an obmc mode is not applied to the current block, and if the value of obmc_flag is 1, it may mean that the obmc mode is applied to the current block.

Whether the OBMC is applied to the current block may be determined depending on an encoding mode of the current block. For example, when the current block is encoded in a merge mode, the OBMC may be implicitly applied to the current block. When the current block is encoded in an intra TMP mode or an IBC mode, the OBMC may not be implicitly applied to the current block. In addition, when the current block is not encoded in the merge mode, the encoder may generate a bitstream including information about whether the OBMC is applied to the current block. The decoder may parse the information about whether the OBMC is applied to the current block, the information being included in the bitstream, so as to determine whether the OBMC is applied to the current block.

In addition, whether OBMC in the unit of a sub-block is performed may be determined depending on the encoding mode of the current block. When the current block has been encoded in an affine mode or an sbTMVP mode, the OBMC may be applied to a sub-block of the current block. In addition, whether the OBMC is applied to the sub-block of the current block may be determined based on specific conditions. That is, the OBMC may be applied to the sub-block of the current block when at least one of the specific conditions is satisfied. The specific conditions may include 1) when a syntax element indicating whether a DMVR mode signaled in SPS is activated is true, 2) when bidirectional prediction is applied to the current block, 3) when reference pictures are in different directions in time order with reference to a current picture, and a POC distance between the current picture and each reference picture is the same, 4) when the current block is not encoded in an Affine mode, 5) when the current block is not encoded in an sbTMVP mode, 6) when the current block is not encoded in a CIIP mode, 7) when the current block is not encoded in an MMVD mode, 8) when the current block is encoded in a merge mode or an AMVP-merge mode, 9) when a weight parameter value for a luminance component and a chrominance component derived from a reference picture of the current block is 0, 10) when the current block is not encoded in a TM merge mode, 11) when the current block is not encoded in a BM merge mode, 12) when a motion vector difference between motion candidates in a motion candidate list and a motion candidate of the current block is within a predetermined value, and 13) when a prediction direction of the current block is not changed to unidirectional prediction by TM. In this case, the predetermined value of 12) may be a value determined according to the size of the current block. For example, when the number of pixels in the current block is less than 64, the predetermined value may be 4, when the number of pixels in the current block is less than 256, the predetermined value may be 8, and when the number of pixels in the current block is equal to or greater than 256, the predetermined value may be 16.

In addition, whether OBMC is applied to the current block and whether OBMC in the unit of a sub-block of the current block is performed may be determined based on whether an MHP mode is applied to the current block. The MHP mode is a method of performing weight prediction based additional information addition to on motion in bidirectional motion information unidirectional and during intra prediction. Therefore, since it has high complexity, when the MHP mode is applied to the current block, the OBMC may not be applied to the current block or a sub-block of the current block. In addition, when the MHP mode is applied to the current block, the decoder may not parse a syntax element related to the OBMC. For example, when the MHP mode is applied to the current block, the value of obmc_flag may be inferred to be 0. Conversely, when the MHP mode is applied to the current block to improve performance, the value of obmc_flag may be inferred to be 1.

Whether OBMC is applied to the current block and whether OBMC in the unit of a sub-block of the current block is performed may be determined depending on whether an AMVP-merge mode is applied to the current block. AMVP-merge is a mode applied to a bidirectional prediction block and is a method of encoding motion information in L0 and L1 directions by using both AMVP and merge. That is, an AMVP mode may be applied to an L0 direction, and a merge mode may be applied to an L1 direction. Conversely, the merge mode may be applied to the L0 direction, and the AMVP mode may be applied to the L1 direction. When the current block is encoded in the merge mode, the OBMC is applied to the current block, and the OBMC in the unit of a sub-block of the current block may be implicitly configured to be performed. In addition, BDOF in the unit of a sub-block may be applied to blocks encoded in an AMVP-merge mode. Therefore, when the AMVP-merge mode is applied to the current block, the OBMC is applied to the current block, and the OBMC in the unit of a sub-block of the current block may be implicitly configured to be performed. When the AMVP-merge mode is applied to the current block, the value of obmc_flag may be inferred to be 1.

Whether OBMC is applied to the current block and whether OBMC in the unit of a sub-block of the current block is performed may be determined depending on whether a skip or MMVD skip mode is applied to the current block. The skip mode is a mode in which there is no information about remaining blocks in blocks encoded in the merge mode. The MMVD skip mode is a mode in which there is no information about remaining blocks in blocks encoded in the MMVD mode. The skip or MMVD skip mode is an effective mode for an area where motion is static, such as the background. In the area where motion is static, since a change in motion between neighboring blocks of the current block is low, it may be more effective not to perform OBMC. Therefore, when the skip or MMVD skip mode is applied to the current block, the OBMC may not be implicitly applied to the current block, and the OBMC in the unit of a sub-block of the current block may not be performed. The decoder may not parse a syntax element related to the OBMC and may infer a value of the syntax element as a predetermined value. For example, the value of obmc_flag may be inferred to be 0.

Whether OBMC is applied to the current block and whether OBMC in the unit of a sub-block of the current block is performed may be determined depending on whether PROF or BDOF is applied to the current block. The PROF is a method of correcting a prediction pixel based on a spatial gradient between pixels in a prediction block, and has a similar effect to the OBMC. Therefore, when the PROF is applied to the current block, the OBMC may not be implicitly applied to the current block. In addition, the OBMC in the unit of a sub-block of the current block may not be performed implicitly. In this case, the value of obmc_flag may be inferred as a value indicating that the OBMC in the unit of a sub-block of the current block is not performed. For example, the value of obmc_flag may be inferred to be 0 (or 1). The BDOF is a method used for bidirectional motion prediction, uses temporal correlation between reference blocks, and may be motion-corrected for each sub-block. Therefore, when the BDOF is applied to the current block, the OBMC may be implicitly applied to the current block, and the OBMC in the unit of a sub-block of the current block may also be implicitly performed. In this case, the value of obmc_flag may be inferred as a value indicating that the OBMC in the unit of a sub-block of the current block is performed. For example, the value of obmc_flag may be inferred to be 1 (or 0).

Whether OBMC is applied to the current block and whether OBMC in the unit of a sub-block of the current block is performed may be determined depending on whether LIC is applied to the current block. The LIC is a method of compensating for a luminance change between blocks and a method of deriving a linear model by using neighboring pixels adjacent to a current block and then compensating for luminance information of the current block through the linear model. After a luminance component is compensated for by the LIC, new reference blocks are weight-averaged by the OBMC, so that an effect of the LIC may be attenuated. Therefore, if the LIC is applied to the current block, the OBMC may not be applied to the current block, and the OBMC in the unit of a sub-block of the current block may not be performed. In this case, the value of obmc_flag may be inferred to be 0.

When the current block is encoded in the merge mode, a motion candidate list may be configured by using motion information of neighboring blocks spatially adjacent to neighboring blocks temporally the current block or adjacent to the current block. The encoder may determine an optimal motion candidate among motion candidates in the motion candidate list, and then generate a bitstream including index information about the optimal motion candidate. The decoder may determine a motion candidate for the current block by parsing the index information. In this case, the motion candidates included in the motion candidate list may be derived from non-adjacent neighboring blocks (neighboring blocks separated by a predetermined distance or more) in addition to the neighboring blocks adjacent to the current block. In this case, the predetermine distance is a value which is changed depending on the horizontal or vertical size of the current block, and may be a positive integer. For example, the predetermine distance may be 8. In this case, motion information derived from the neighboring blocks adjacent to the current block may include at least one of prediction direction information (e.g., L0 prediction, L1 prediction, and bidirectional prediction), a motion vector, BCW index information, LIC information, MHP information, and half-pixel MC application information. In this case, if the LIC is applied to a neighboring block which is not adjacent to the current block, the correlation with a luminance compensation value of the current block is low, whether the LIC is applied to the current block may be reconfigured based on the motion information derived from the neighboring block. That is, a motion information value in the motion candidates may be preconfigured according to the location and distance of the neighboring block and used as a motion candidate for the current block. For example, LIC information among motion information of motion candidates derived from the neighboring blocks which are not adjacent to the current block may be reconfigured so that the LIC is not applied. Alternatively, when the current block is encoded in the merge mode, the OBMC may be applied regardless of whether the LIC is applied. Alternatively, when the current block is not encoded in the merge mode and the LIC is applied, the OBMC may not be applied. Alternatively, when the LIC is applied to at least one block among the neighboring blocks or the current block, the OBMC may not be applied to the current block. This is a measure for eliminating a situation where blocks to which LIC is applied and blocks to which LIC is not applied are mixed among prediction blocks used for weight-averaging in the OBMC process.

The LIC is applied only when the current block correspond to unidirectional motion prediction. However, when the current block is encoded in the merge mode, the current block is mostly encoded with bidirectional motion prediction. However, when the current block is encoded in the merge mode, and motion information of a derived motion candidate corresponds to bidirectional prediction and indicates that the LIC is applied (or when a prediction direction of the current block is bidirectional prediction and the LIC is applied), both the LIC and the OBMC may not be performed. To solve this constraint situation, when the current block is encoded in the merge mode, the OBMC may be performed regardless of whether the LIC is applied. Alternatively, when the current block is encoded in the merge mode, and the motion information of the derived motion candidate corresponds to unidirectional prediction and indicates that the LIC is applied (or when the LIC is applied to the current block), the OBMC may not be performed. Alternatively, when the current block is not encoded in the merge mode and the LIC is applied, the OBMC may not be performed. Alternatively, in order to increase the effect of the OBMC, when the current block is encoded in the merge mode, and the motion information of the derived motion candidate corresponds to unidirectional prediction and indicates that the LIC is applied (or when the LIC is applied to the current block), the OBMC may be performed. In addition, when the current block is encoded in the merge mode, and the motion information of the derived motion candidate corresponds to bidirectional prediction and indicates that the LIC is applied (or when the LIC is applied to the current block), the OBMC may be performed. Alternatively, when the current block is encoded in the merge mode, the motion information of the derived motion candidate corresponds to unidirectional prediction and indicates that the LIC is applied (or when the LIC is applied to the current block), and a parameter value for performing the LIC is within a predetermined value, the OBMC may be performed.

Whether OBMC is applied to the current block and whether OBMC in the unit of a sub-block of the current block is performed may be determined depending on the size of the current block. Generally, a background area is encoded with a large-sized block. In the background area, a motion change between neighboring blocks of the current block is low, and thus it may be better for the OBMC not to be performed. Therefore, when the horizontal and vertical sizes of the current block are larger than a predetermined value, the OBMC is not implicitly applied to the current block, and the OBMC in the unit of a sub-block of the current block may also not be performed. In this case, the predetermined value is a positive integer and may be 64. For example, when the horizontal and vertical sizes of the current block are greater than 64, the OBMC is not applied to the current block, and the OBMC in the unit of a sub-block of the current block may also not be performed. Alternatively, when the horizontal and vertical sizes of the current block are smaller than 128, the OBMC may be applied to the current block. When the horizontal and vertical sizes of the current block are equal to or greater than 128, the OBMC is not be applied to the current block, and the OBMC in the unit of a sub-block of the current block may also not be performed. In addition, a syntax element related to the OBMC is not parsed and may be inferred as a fixed value. For example, when the horizontal and vertical sizes of the current block are greater than 64, the value of obmc_flag may be inferred to be 0.

Whether OBMC in the unit of a sub-block is performed may be determined depending on an encoding mode of the current block and whether OBMC is applied to the current block. The OBMC in the unit of a sub-block may not be effective for a specific image such as screen content. Therefore, a measure for controlling whether an OBMC method in the unit of a sub-block is activated in a specific image is required.

FIG. 23 illustrates a method of signaling information indicating whether OBMC in the unit of a sub-block is activated, according to an embodiment of the present disclosure.

Referring to FIG. 23, the decoder may parse sps_disabled_subblock_obmc_flag, based on sps_obmc_enabled_flag. Specifically, the decoder may parse sps_disabled_subblock_obmc_flag when a value of sps_obmc_enabled_flag is 1 (i.e., true). sps_obmc_enabled_flag may be a syntax element (flag) indicating whether OBMC is activated in a CLVS, and if the value of sps_obmc_enabled_flag is 1, indicate that the OBMC is activated in the CLVS, and if the value of sps_obmc_enabled_flag is 0, indicate that the OBMC is inactivated in the CLVS. If sps_obmc_enabled_flag is not parsed, the value of sps_obmc_enabled_flag may be inferred to be 0 (sps_obmc_enabled_flag equal to 1 specifies that the OBMC (Overlapped Block Motion Compensation) is enabled for the CLVS. sps_obmc_enabled_flag equal to 0 specifies that the OBMC (Overlapped Block Motion Compensation) is disabled for the CLVS. When sps_obmc_enabled_flag is not present, it is inferred to be equal to 0). sps_disabled_subblock_obmc_flag may be a syntax element indicating whether OBMC in the unit of a sub-block is deactivated, and if a value of sps_disabled_subblock_obmc_flag is 1, indicate that the OBMC in the unit of a sub-block is deactivated, and if the value of sps_disabled_subblock_obmc_flag is 0, indicate that the OBMC in the unit of a sub-block is activated. If sps_disabled_subblock_obmc_flag is not parsed, the value of sps_disabled_subblock_obmc_flag may be inferred to be 0 (sps_subblock_obmc_disabled_flag equal to 1 specifies that the OBMC in sub-block is disabled for the CLVS. sps_subblock_obmc_disabled_flag equal to 0 specifies that the OBMC in sub-block is enabled for the CLVS. When sps_subblock_obmc_disabled_flag is not present, it is inferred to be equal to 0). In other words, if the value of sps_disabled_subblock_obmc_flag is 1, it may mean that the OBMC is not performed on all sub-blocks of a current block. If the value of sps_disabled_subblock_obmc_flag is 0, it may mean that the OBMC can be performed on a sub-block of the current block, and whether the OBMC is performed on each sub-block may be determined based on an encoding mode of the current block, whether the OBMC is applied to the current block, etc. The syntax elements of FIG. 23 may be signaled (parsed) at an SPS level.

A bitstream may be configured by one or more coded video sequences (CVS), and one CVS may be encoded independently from other CVSs. Each CVS may be configured by one or more layers, and each layer may represent a specific image quality and a specific resolution, or represent a general image, a depth information map, and a transparency map. In addition, a coded layer video sequence (CLVS) may refer to a layer-wise CVS configured by consecutive PUs (in decoding order) within the same layer. For example, a CLVS may exist for a layer representing a specific image quality, and a CLVS may exist for a depth information map.

When the size of the current block is larger than a specific size, the OBMC may not be effective. Therefore, whether the OBMC is activated may be determined based on the size of the current block. In addition, the maximum CTU size may be changed depending on the resolution of an image, the maximum block size in which the OBMC may be activated may be determined depending on the size of the image.

FIG. 24 illustrates a method of signaling information indicating the maximum block size for activation of OBMC according to an embodiment of the present disclosure.

Referring to FIG. 24, sps_log2_obmc_max_size_idx may be parsed based on sps_obmc_enabled_flag. Specifically, the decoder may parse sps_log2_obmc_max_size_idx when a value of sps_obmc_enabled_flag is 1 (i.e., true). sps_log2_obmc_max_size_idx may be a syntax element indicating the maximum block size for which OBMC may be activated. In this case, the value of sps_log2_obmc_max_size_idx is an integer greater than 0 and may have a value of 0 to 2. If the value of sps_log2_obmc_max_size_idx is 0, the maximum block size may be ½ of the maximum CTU size. If the value of sps_log2_obmc_max_size_idx is 1, the maximum block size may be ¼ of the maximum CTU size. If the value of sps_log2_obmc_max_size_idx is 2, the maximum block size may be ⅛ of the maximum CTU size. If sps_log2_obmc_max_size_idx is not parsed, the value of sps_log2_obmc_max_size_idx may be inferred to be 0. The syntax elements of FIG. 24 may be signaled (parsed) at an SPS level.

The current block may be divided into two areas according to a GPM mode, and blending may be applied to a boundary between the two areas. The blending may not be effective for a specific image such as screen content. Therefore, a method of activating blending in a GPM mode in a specific image is needed. The blending may have the same meaning as the OBMC described herein.

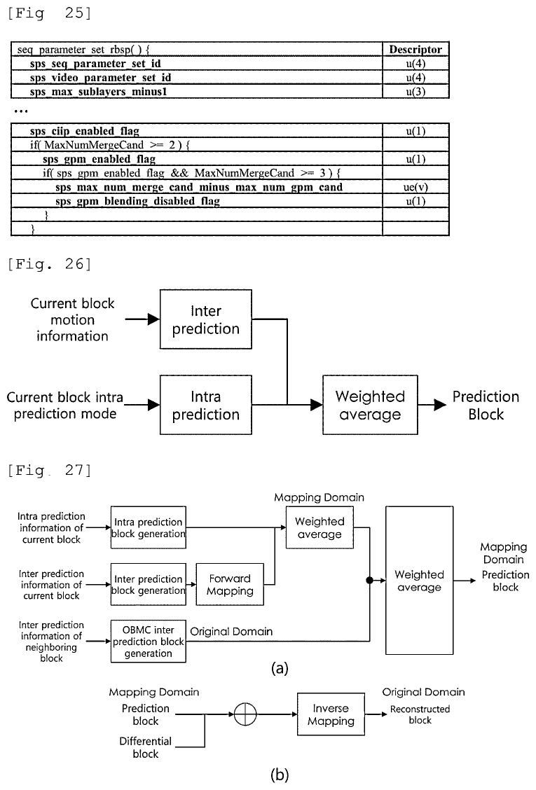

FIG. 25 illustrates a method of signaling information for activating blending in a GPM mode according to an embodiment of the present disclosure.

Referring to FIG. 25, the decoder may parse sps_gpm_blending_disabled_flag, based on sps_gpm_enabled_flag. Specifically, the decoder may parse sps_gpm_blending_disabled_flag when a value of sps_gpm_enabled_flag is 1 (i.e., true). sps_gpm_enabled_flag may be a syntax element (flag) indicating whether a GPM mode is activated in a CLVS, and if the value of sps_gpm_enabled_flag is 1, indicate that the GPM mode is activated in the CLVS, and if the value of sps_gpm_enabled_flag is 0, indicate that the GPM mode is inactivated in the CLVS. sps_gpm_blending_disabled_flag may be a syntax element indicating whether blending in the GPM mode is inactivated in the CLVS, and if a value of sps_gpm_blending_disabled_flag is 1, indicate that the blending in the GPM mode is inactivated in the CLV, and if the value of sps_gpm_blending_disabled_flag is 0, indicate that the blending in the GPM mode is activated in the CLVS. If sps_gpm_blending_disabled_flag is not parsed, the value of sps_gpm_blending_disabled_flag may be inferred to be 0 (sps_gpm_blending_disabled_flag equal to 1 specifies that the blending for the geometric partition based motion compensation is disabled for the CLVS. sps_gpm_blending_disabled_flag equal to 0 specifies that the blending for the geometric partition based motion compensation is enabled the CLVS. When for sps_gpm_blending_disabled_flag is not present, it is inferred to be equal to 0). In other words, if the value of sps_gpm_blending_disabled_flag is 0, it may mean that the blending is not performed when the current block is encoded in the GPM mode. If the value of sps_gpm_blending_disabled_flag is 1, it may mean that the blending is performed when the current block is encoded in the GPM mode.

Luma mapping with chroma scaling (LMCS) may refer to a preprocessing process which dynamically changes an expression range of an input image signal in order to improve encoding performance and subjective image quality. Specifically, the LMCS is a method of dynamically changing an expression range of a pixel value and may be a method including luminance component mapping and chrominance component scaling. The luminance component mapping may refer to a method of reconfiguring a dynamic range of a luminance component of an input image through mapping, and the chrominance component scaling may refer to a method of compensating for a gap between a mapped luminance component and a chrominance component. When a current image is encoded, the input image may be converted to a dynamic range through a forward mapping process, and inverse mapping may be performed on a reconstructed image to convert the reconstructed image back to an original expression range. The encoder may perform forward mapping by dividing the existing dynamic area into 16 equal intervals and then redistributing a codeword of the input image through a linear model for each interval. The encoder may perform inverse mapping, which performs inverse mapping from a mapped dynamic area to the existing dynamic area. The encoder may generate a bitstream including parameters related to forward mapping and inverse mapping.

FIG. 26 illustrates a method of generating a prediction block of a current block by using a CIIP mode according to an embodiment of the present disclosure.

Referring to FIG. 26, when a CIIP method is performed, the decoder may perform inter prediction based on motion information of a current block to generate a prediction block of the current block, and perform weight-averaging of a prediction block of the current block generated by performing intra prediction based on an intra prediction mode of the current block, so as to generate a final prediction block of the current block. In this case, a weight for each of the prediction block generated by performing inter prediction and the prediction block generated by performing intra prediction may be determined depending on whether a neighboring block adjacent to the current block is an intra prediction block or an inter prediction block.

FIGS. 27 to 32 illustrate a method in which OBMC is applied to a prediction block according to CIIP according to an embodiment of the present disclosure.

Referring to case (a) of FIG. 27, in a CIIP mode, the decoder may generate an intra prediction block (Intra_{predY}) of a current block by performing intra prediction based on intra prediction information of the current block. In addition, the decoder may generate an inter prediction block (Inter_{predY}) of the current block by performing inter prediction based on inter prediction information of the current block. In this case, when LMCS is applied to the current block, the intra prediction block is a block in a first domain, and the inter prediction block is a block in a second domain. That is, the domains of the intra prediction block and the inter prediction block are different. Therefore, the decoder is required to change a domain by performing forward mapping on the inter prediction block. In this case, the first domain may be a mapping domain, and the second domain may be an original domain (a domain of the current block, an original domain). Specifically, the decoder may perform forward mapping on the inter prediction block to acquire an inter prediction block in the mapping domain (FwdMap(Inter_{predY})) in Equation 1). Further, the decoder may generate a CIIP prediction block (CIIP_{predY}) in the mapping domain by performing weight-averaging of the intra prediction block and the inter prediction block, based on Equation 1. w₀ in Equation 1 is a weight and may be a preconfigured value.

$$[ Equation 1 ]$$

$${CIIP}_{predY} = \frac{( 4 - {w}_{0} ) \times FwdMap ( {Inter}_{predY} ) + {w}_{0} \times {Intra}_{predY}}{4}$$

When OBMC is applied to the current block, the decoder may generate an OBMC inter prediction block (OBMCpredY), based on motion information of a neighboring block adjacent to the current block. Further, the decoder may generate a final prediction block (PredY) of the current block in the mapping domain by performing weight-averaging of the OBMC inter prediction block and a CIIP prediction block, based on Equation 2. w₁ in Equation 2 is a weight and may be a preconfigured value.

$$PredY = \frac{( 128 - {w}_{1} ) \times {CIIP}_{predY} + {w}_{1} \times {OBMC}_{predY}}{128} \qquad [ Equation 2 ]$$

Referring to case (b) of FIG. 27, the decoder adds a differential block to the final prediction block of the current block acquired based on Equation 2, then performs inverse mapping to generate a reconstructed block of the current block. That is, a block in the mapping domain may be converted to a block in the original domain through inverse mapping.

Since the OBMC inter prediction block is a prediction block in the original domain, switching of the domain of the OBMC inter prediction block is required to be performed in order for weight-averaging with the CIIP prediction block to be performed.

Referring to FIG. 28, the decoder may perform forward mapping on an OBMC inter prediction block to acquire an OBMC inter prediction block in the mapping domain. Further, a final prediction block of the current block may be generated by performing weight-averaging of a CIIP prediction block and the OBMC inter prediction block in the mapping domain. That is, as in Equation 3, OBMC_{predY} in Equation 2 may be replaced with the OBMC inter prediction block FwdMap (OBMC_{predY}) in the mapping domain where forward mapping has been performed.

$$[ Equation 3 ]$$

$$PredY = \frac{( 128 - {w}_{1} ) \times {CIIP}_{predY} + {w}_{1} \times FwdMap ( {OBMC}_{pr edY} )}{128}$$

Referring to FIG. 29, unlike FIG. 28, the decoder may perform inverse mapping on a CIIP prediction block without performing forward mapping on an OBMC inter prediction block, so as to acquire a CIIP prediction block (InvMap(CIIP_{predY})) in the original domain, and perform weight-averaging of the OBMC inter prediction block and the CIIP prediction block in the original domain to generate a final prediction block of the current block. In this case, since weight-averaging is performed in the original domain, in order to generate a final prediction block of the current block in the mapping domain, the decoder may switch to the mapping domain by performing forward mapping on a result of weight-averaging of the OBMC inter prediction block and the CIIP prediction block in the original domain. That is, the final prediction block of the current block may be generated based on Equation 4. w₁ in Equation 4 is a weight and may be a preconfigured value.

$$[ Equation 4 ]$$

$$PredY = FwdMap ( \frac{( 128 - {w}_{1} ) \times InvMap ( {CIIP}_{predY} ) + {w}_{1} \times {OBMC}_{predY}}{128} )$$

If weight-averaging is performed multiple times, it may not be effective in terms of computational complexity. That is, if the weight-averaging is repeated, a problem of delayed processing speed may occur. Accordingly, a method of reducing computational complexity and preventing delays in processing speed is required.

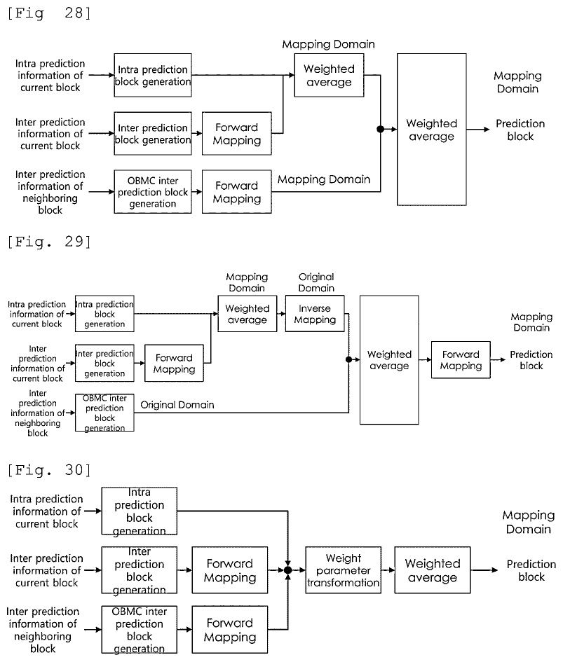

Referring to FIG. 30, the decoder may perform weight-averaging only one time to generate a final prediction block of the current block. Specifically, the decoder may perform forward mapping on an inter prediction block to acquire an inter prediction block (FwdMap(Inter_{predY})) in the mapping domain. The decoder may perform forward mapping on an OBMC inter prediction block to acquire an OBMC inter prediction block (FwdMap(OBMC_{predY})) in the mapping domain. That is, the predY decoder may enable an intra prediction block, an inter prediction block, and an OBMC prediction block to all exist in the same mapping domain. The decoder may convert a weighting parameter. That is, the decoder may acquire a new weight for each prediction block. The decoder may generate a final prediction block of the current block by performing weight-averaging of the OBMC prediction block, the inter prediction block, and the intra prediction block in the mapping domain by using the new weight as shown in Equation 5.

$$[ Equation 5 ]$$

$$PredY = \frac{\begin{matrix}( α \times {Intra}_{predY} + β \times FwdMap ( {Inter}_{predY} ) + \\ γ \times FwdMap ( {OBMC}_{predY} ) )\end{matrix}}{k}$$

α, β, and γ in Equation 5 are new weights for each prediction block, and k may be a predetermined constant.

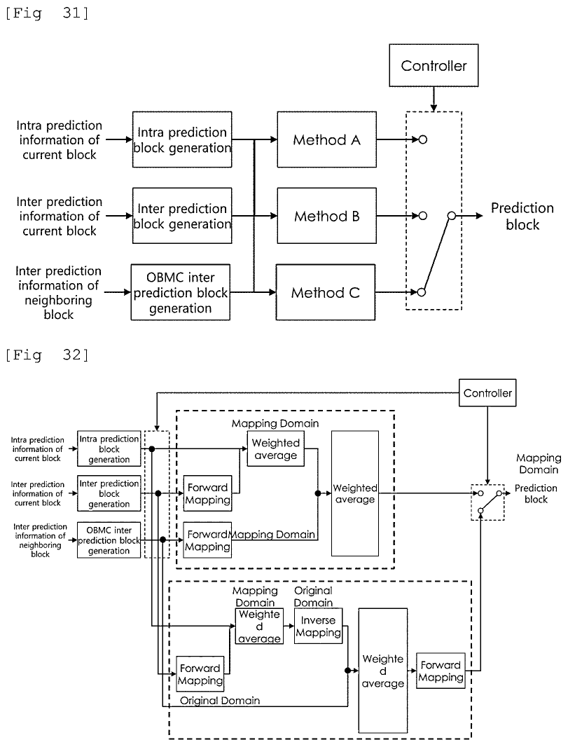

Referring to FIG. 31, a controller may select an optimal method among methods A, B, and C to generate a final prediction block of the current block. In this case, the methods A, B, and C may be the methods described through FIGS. 28 to 30, respectively. In this case, the controller may be a processor included in the encoder. FIG. 32 is a more detailed view of FIG. 31. That is, the methods of generating a final prediction block of a current block described with reference to FIGS. 28 to 30 may have different encoding performances. Therefore, the encoder may generate a bitstream including information (selection_idx) indicating a method with optimal encoding performance. Further, the decoder may generate a final prediction block of the current block according to a method determined by parsing selection_idx. selection_idx may be used independently for each of a luminance component block and a chrominance component block. That is, a prediction block may be generated using different methods for each of the luminance component block and the chrominance component block.

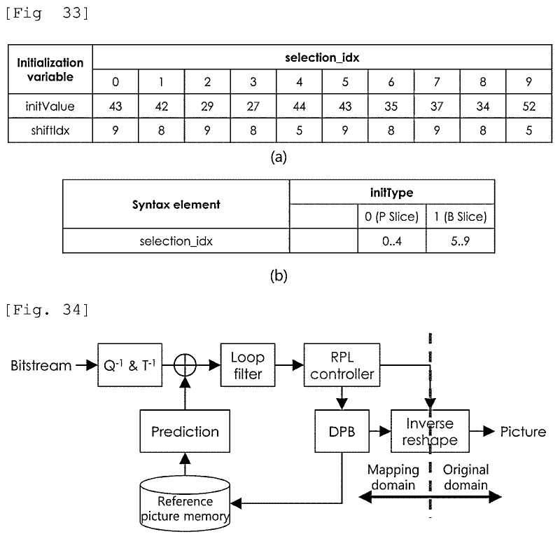

FIG. 33 illustrates a context model according to an embodiment of the present disclosure.

FIG. 33 illustrates a context model for selection_idx. The encoder may entropy-code selection_idx by using CABAC. The context model for selection_idx may be defined as a value obtained through an experiment.

Referring to case (a) of FIG. 33, initValue represents a context model for “selection_idx”, and shiftIdx may be used when updating the probability for “selection_idx”. The initValue may be determined depending on the type of a current slice. That is, the initValue may be determined depending on whether the current slice is a P slice or a B slice. Case (b) of FIG. 33 illustrates a context model which may be used according to each slice type. For example, if the type of the current slice is the P slice, selection_idx may be a value of 0 and 4. If the type of the current slice is the B slice, selection_idx may be a value of 5 to 9. In this case, an initValue value corresponding to a value of selection_idx may be used according to case (a) of FIG. 33.

There may be at least one “initValue” used for each slice type. As an embodiment, when only one “initValue” is defined for slice, if the type of the current slice is the P slice, “initValue” may use a value of 0, and if the type of the current slice is the B slice, “initValue” may use a value of 5.

In addition, the use of “initValue” according to the slice type may be selectively applied to each slice. As an embodiment, the order of use of an “initValue” value may be changed a depending on value of “sh_cabac_init_flag” defined in a slice header. When the value of “sh_cabac_init_flag” is “1”, if the type of the current slice is the P slice, “initValue” may use a value of 5, and if the type of the current slice is the B slice, “initValue” may use a value of 0. When the value of “sh_cabac_init_flag” is “0”, if the type of the current slice is the P slice, “initValue” may use a value of 0, and if the type of the current slice is the B slice, “initValue” may use a value of 5.

Hereinafter, a method of selecting one of several context models (indexes) for a symbol of selection_idx will be described.

i) A context index may be selected based on selection_idx in neighboring blocks of a current block. For example, the context index may be determined based on the sum of selection_idx of a neighboring block adjacent to the left side of the current block and selection_idx of a neighboring block adjacent to the upper side of the current block. The context index may be a value of 0 to 2. If the neighboring block is at an unusable location, 0 may be added.

ii) A context index may be selected depending on whether selection_idx values of the neighboring blocks of the current block are the same. For example, if the selection_idx values of the neighboring blocks adjacent to the left and upper sides of the current block are the same, the context index may be determined to be 2. If the selection_idx values of the neighboring blocks adjacent to the left and upper sides of the current block are different from each other, the context index may be determined to be 1. If the selection_idx values of the neighboring blocks adjacent to the left and upper sides of the current block do not exist, the context index may be determined to be 0.

iii) A context index may be determined based on the size of the current block. If the size of the current block is larger than a first value, the context index may be 2, and if the size of the current block is smaller than a second value, the context index may be 0. In other cases, the context index may be 1. For example, the first value may be 32×32 and the second value may be 16×16. In addition, the first value and the second value may be determined as the sum of the horizontal and vertical sizes of the current block.

iv) If the current block is a chrominance component block and is encoded in a dual tree manner, a context model may be determined based on a value of selection_idx of a luminance component block of the current block. For example, if the value of selection_idx of the luminance component block of the current block is 0, a context index of the chrominance component block of the current block may be 0. If the value of selection_idx of the luminance component block of the current block is 1, the context index of the chrominance component block of the current block may be 1. In this case, the context index of the chrominance component block may be the same as or different from a context index of the luminance component block.

v) If the current block is a chrominance component block and is encoded in a dual tree manner, a context index of selection_idx may be determined through the methods i) to iii) described above.

vi) selection_idx may be binary-arithmetic-coded in a bypass form using a fixed probability interval without being binary-arithmetic-coded through a context index. Binary arithmetic coding in a bypass form may be selectively applied to each of the luminance component block and the chrominance component block. For example, binary arithmetic coding through a context index may be performed on the luminance component block, and binary arithmetic coding in a bypass form may be performed on the chrominance component block. Conversely, binary arithmetic coding through a context index may be performed on the chrominance component block, and binary arithmetic coding in a bypass form may be performed on the luminance component block.

vii) selection_idx may be binary-arithmetic-coded using only one context model. A context index is not derived, and a specific context index may be used for all blocks in a slice. This is because only one context index can exist depending on a current slice type.

When selection_idx is included in a bitstream, the bit amount may increase. To reduce the bit amount, selection_idx is not included in the bitstream, and the decoder may select an optimal method by using information about the current block and information about neighboring blocks of the current block. That is, the optimal method may be selected by using at least one of information on neighboring blocks adjacent to the current block, information on a color component of the current block (whether the current block is a luminance component block or a chrominance component block), quantization parameter information, the horizontal or vertical size of the current block, a weight calculated from the neighboring blocks of the current block, a weight of a CIIP block, and an OBMC weight. Hereinafter, embodiments of selecting an optimal method will be described.

a) When all the neighboring blocks of the current block are encoded in an intra prediction mode, the method described with reference to FIG. 28 may be selected. This is because a weight of an intra prediction block is high in CIIP.

b) If the OBMC weight is larger among the weight of the CIIP block and the OBMC weight, the method described with reference to FIG. 29 may be selected.

c) If the horizontal or vertical size of the current block is within (or equal to or greater than) a specific value, the method described with reference to FIG. 28 may be selected. Otherwise, the method described with reference to FIG. 29 may be selected. In this case, the specific value may be 16 as a positive integer.

An LMCS method increases encoding performance, but reduces computational complexity and processing speed. That is, when encoding is performed, the encoding is processed in a mapping domain, but when a reconstructed picture is stored, inverse mapping is performed and the reconstructed picture is stored in an original domain. The stored picture may be used as a reference picture. A block of the stored picture in the original domain may be converted to the mapping domain and used as a reference block. That is, since the domains between the reference picture and the neighboring blocks are different during an encoding process, forward and inverse mapping are required to be performed. In order to simplify this computational complexity and process of processing different domains, the reconstructed picture may be stored in the mapping domain when stored as a reference picture. In this case, when a reference picture in the mapping domain is not used again as a reference picture in the future, the reference picture in the mapping domain may be output to an output buffer and converted into a picture in the original domain through inverse mapping. Accordingly, encoding and decoding processes are performed only in the mapping domain, and thus forward mapping or inverse mapping does not need to be performed.

Information indicating a domain of a current reference picture may be stored in a memory.

FIG. 34 illustrates an LMCS method according to an embodiment of the present disclosure.

FIG. 34 illustrates an LMCS method in the unit of a picture (or frame) from a decoder perspective.

The decoder may parse a quantized transformation coefficient in an input bitstream, generate an error signal through inverse quantization and inverse transformation, derive a reference block from a reference picture memory, and then generate a reconstructed block by adding the error signal and the reference block. In this case, a picture stored in the reference picture memory may be a picture in a mapping domain, and the reconstructed block may also be a block in the mapping domain. The decoder may perform subjective image quality processing by performing a loop on filter the reconstructed block, and then store the reconstructed block in a decoded picture buffer (DPB) according to a command of a reference picture list controller (RPL controller) to determine whether to use the reconstructed block as a reference picture or whether to output the reconstructed block directly without using the same as a reference picture. If the reconstructed block is stored as the reference picture, the reconstructed picture in the mapping domain may be stored in the DPB. If the reconstructed block is output directly without being used as the reference picture and, inverse mapping may be performed on the reconstructed picture in the mapping domain, and thus the reconstructed picture may be converted to a picture in an original domain and then output. In addition, when a specific picture in the DPB is no longer used as the reference picture according to the command from the reference picture list controller (RPL controller), the corresponding specific picture in the DPB may be removed from the DPB and then output. In this case, the decoder may perform inverse mapping on the picture removed from the DPB, convert the picture to the picture in the original domain, and output the converted picture.

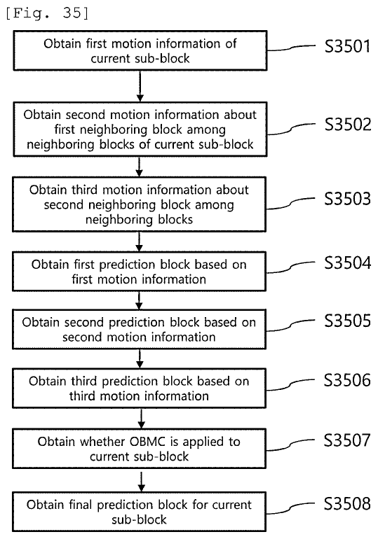

FIG. 35 illustrates a method of acquiring a prediction block of a current sub-block according to an embodiment of the present disclosure.

Referring to FIG. 35, a method of acquiring a prediction block of a current sub-block described with reference to FIGS. 1 to 35 will be described.

The decoder may acquire first motion information of a current sub-block (S3501). The decoder may acquire second motion information about a first neighboring block among neighboring blocks of the current sub-block (S3502). The decoder may acquire third motion information about a second neighboring block among the neighboring blocks (S3503). The decoder may acquire a first prediction block based on the first motion information, acquire a second prediction block based on the second motion information, and acquire a third prediction block based on the third motion information (S3504, S3505, and S3506). The decoder may identify whether OBMC is applied to the current sub-block (S3507). When the OBMC is applied to the current sub-block, the decoder may select one or more prediction blocks which satisfy a preconfigured condition among the second prediction block and the third prediction block, and perform the OBMC based on the one or more prediction blocks and the first prediction block to acquire a final prediction block for the current sub-block (S3508).

The preconfigured condition corresponds to a condition based on a first similarity between the first prediction block and the second prediction block and a second similarity between the first prediction block and the third prediction block. The one or more prediction blocks may be prediction blocks corresponding to a similarity determined by comparing each of a value indicating the first similarity and a value indicating the second similarity with a preconfigured value. Specifically, the one or more prediction blocks may be prediction blocks corresponding to a similarity smaller than a preconfigured value by comparing each of a value indicating the first similarity and a value indicating the second similarity with the preconfigured value. The final prediction block may be acquired by performing weight-averaging of the one or more prediction blocks and the first prediction block.

When the OBMC is applied to at least one block among the current sub-block, the second prediction block, and the third prediction block, deblocking filtering may not performed on the current sub-block.

When a CIIP mode is applied to the current sub-block, the current sub-block may be divided into an inter prediction block of the current sub-block based on an inter prediction mode and an intra prediction block of the current sub-block based on an intra prediction mode. In this case, the intra prediction block may be a block in a first domain, the inter prediction block may be a block in a second domain, and the one or more prediction blocks may be blocks in the second domain. In this case, the first domain and the second domain may be different domains. The decoder may perform forward mapping on the inter prediction block to acquire an inter prediction block in the first domain, and perform the forward mapping on the one or more prediction blocks to acquire one or more prediction blocks in the first domain. The decoder may perform weight-averaging of the inter prediction block, the intra prediction block in the first domain, and the one or more prediction blocks in the first domain to acquire a final prediction block of the current sub-block.

The current sub-block may be included in a coding block, and the current sub-block may be a sub-block which does not include a boundary of the coding block. The neighboring blocks may be included in the coding block, and the neighboring blocks may be sub-blocks including the boundary of the coding block. In this case, when the number of blocks to which the OBMC is applied among the neighboring blocks is smaller than a first value, the OBMC may not be applied to the current sub-block.

Whether the OBMC is applied to the current sub-block may be determined by a syntax element included in a bitstream. In this case, the syntax element may be signaled at an SPS level.

A GPM mode may be applied to the current sub-block. In this case, the current sub-block may be divided into a first area and a second area. When at least one area among the first area and the second area is encoded in an intra mode, the OBMC may not be applied to the current sub-block. In this case, when neighboring blocks adjacent to the first area are blocks which are pre-reconstructed, and neighboring blocks adjacent to the second area are blocks which are not pre-reconstructed, the final prediction block may be acquired based on motion information of the first area.

The above methods described in the present specification may be performed by a processor in a decoder or an encoder. Furthermore, the encoder may generate a bitstream that is decoded by a video signal processing method. Furthermore, the bitstream generated by the encoder may be stored in a computer-readable non-transitory storage medium (recording medium).

The present specification has been described primarily from the perspective of a decoder, but may function equally in an encoder. The term “parsing” in the present specification has been described in terms of the process of obtaining information from a bitstream, but in terms of the encoder, may be interpreted as configuring the information in a bitstream. Thus, the term “parsing” is not limited to operations of the decoder, but may also be interpreted as the act of configuring a bitstream in the encoder. Furthermore, the bitstream may be configured to be stored in a computer-readable recording medium.

The above-described embodiments of the present invention may be implemented through various means. For example, embodiments of the present invention may be implemented by hardware, firmware, software, or a combination thereof.

For implementation by hardware, the method according to embodiments of the present invention may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the case of implementation by firmware or software, the method according to embodiments of the present invention may be implemented in the form of a module, procedure, or function that performs the functions or operations described above. The software code may be stored in memory and driven by a processor. The memory may be located inside or outside the processor, and may exchange data with the processor by various means already known.

Some embodiments may also be implemented in the form of a recording medium including computer-executable instructions such as a program module that is executed by a computer. Computer-readable media may be any available media that may be accessed by a computer, and may include all volatile, nonvolatile, removable, and non-removable media. In addition, the computer-readable media may include both computer storage media and communication media. The computer storage media include all volatile, nonvolatile, removable, and non-removable media implemented in any method or technology for storing information such as computer-readable instructions, data structures, program modules, or other data. Typically, the communication media include computer-readable instructions, other data of modulated data signals such as data structures or program modules, or other transmission mechanisms, and include any information transfer media.

The above-mentioned description of the present invention is for illustrative purposes only, and it will be understood that those of ordinary skill in the art to which the present invention belongs may make changes to the present invention without altering the technical ideas or essential characteristics of the present invention and the invention may be easily modified in other specific forms. Therefore, the embodiments described above are illustrative and are not restricted in all aspects. For example, each component described as a single entity may be distributed and implemented, and likewise, components described as being distributed may also be implemented in an associated fashion.

The scope of the present invention is defined by the appended claims rather than the above detailed description, and all changes or modifications derived from the meaning and range of the appended claims and equivalents thereof are to be interpreted as being included within the scope of present invention.

1. A video signal decoding device comprising
a processor,
wherein the processor is configured to:
acquire first motion information of a current sub-block;
acquire second motion information about a first neighboring block among neighboring blocks of the current sub-block;
acquire third motion information about a second neighboring block among the neighboring blocks;
acquire a first prediction block based on the first motion information;
acquire a second prediction block based on the second motion information;
acquire a third prediction block based on the third motion information;
identify whether OBMC is applied to the current sub-block;
when the OBMC is applied to the current sub-block, select one or more prediction blocks which satisfy a preconfigured condition among the second prediction block and the third prediction block; and
perform the OBMC based on the one or more prediction blocks and the first prediction block to acquire a final prediction block for the current sub-block.

2. The decoding device of claim 1, wherein the preconfigured condition corresponds to a condition based on a first similarity between the first prediction block and the second prediction block and a second similarity between the first prediction block and the third prediction block.

3. The decoding device of claim 2, wherein the one or more prediction blocks are prediction blocks corresponding to a similarity determined by comparing each of a value indicating the first similarity and a value indicating the second similarity with a preconfigured value.

4. The decoding device of claim 2, wherein the one or more prediction blocks are prediction blocks corresponding to a similarity smaller than a preconfigured value by comparing each of a value indicating the first similarity and a value indicating the second similarity with the preconfigured value.

5. The decoding device of claim 1, wherein the final prediction block is acquired by performing weight-averaging of the one or more prediction blocks and the first prediction block.

6. The decoding device of claim 1, wherein when the OBMC is applied to at least one block among the current sub-block, the second prediction block, and the third prediction block, deblocking filtering is not performed on the current sub-block.

7. The decoding device of claim 1, wherein a CIIP mode is applied to the current sub-block,
the current sub-block is divided into an inter prediction block of the current sub-block based on an inter prediction mode and an intra prediction block of the current sub-block based on an intra prediction mode,
the intra prediction block is a block in a first domain,
the inter prediction block is a block in a second domain,
the one or more prediction blocks are blocks in the second domain,
the first domain and the second domain are different domains, and
the processor is configured to:
perform forward mapping on the inter prediction block to acquire an inter prediction block in the first domain;
perform the forward mapping on the one or more prediction blocks to acquire one or more prediction blocks in the first domain; and
perform weight-averaging of the inter prediction block, the intra prediction block in the first domain, and the one or more prediction blocks in the first domain to acquire a final prediction block of the current sub-block.

8. The decoding device of claim 1, wherein the current sub-block is included in a coding block, and the current sub-block is a sub-block which does not include a boundary of the coding block,
the neighboring blocks are included in the coding block, and the neighboring blocks are sub-blocks including the boundary of the coding block, and
when the number of blocks to which the OBMC is applied among the neighboring blocks is smaller than a first value, the OBMC is not applied to the current sub-block.

9. The decoding device of claim 1, wherein whether the OBMC is applied to the current sub-block is determined by a syntax element included in a bitstream.

10. The decoding device of claim 9, wherein the syntax element is signaled at an SPS level.

11. The decoding device of claim 1, wherein a GPM mode is applied to the current sub-block,
the current sub-block is divided into a first area and a second area, and
when at least one area among the first area and the second area is encoded in an intra mode, the OBMC is not applied to the current sub-block.

12. The decoding device of claim 11, wherein when neighboring blocks adjacent to the first area are blocks which are pre-reconstructed, and neighboring blocks adjacent to the second area are blocks which are not pre-reconstructed, the final prediction block is acquired based on motion information of the first area.

13. A video signal encoding device comprising
a processor,
wherein the processor is configured to acquire a bitstream decoded by a decoding method, and
the decoding method comprises:
acquiring first motion information of a current sub-block;
acquiring second motion information about a first neighboring block among neighboring blocks of the current sub-block;
acquiring third motion information about a second neighboring block among the neighboring blocks;
acquiring a first prediction block based on the first motion information;
acquiring a second prediction block based on the second motion information;
acquiring a third prediction block based on the third motion information;
identifying whether OBMC is applied to the current sub-block;
when the OBMC is applied to the current sub-block, selecting one or more prediction blocks which satisfy a preconfigured condition among the second prediction block and the third prediction block; and
performing the OBMC based on the one or more prediction blocks and the first prediction block to acquire a final prediction block for the current sub-block.

14. The encoding device of claim 13, wherein the preconfigured condition corresponds to a condition based on a first similarity between the first prediction block and the second prediction block and a second similarity between the first prediction block and the third prediction block.

15. The encoding device of claim 14, wherein the one or more prediction blocks are prediction blocks corresponding to a similarity determined by comparing each of a value indicating the first similarity and a value indicating the second similarity with a preconfigured value.

16. The encoding device of claim 14, wherein the one or more prediction blocks are prediction blocks corresponding to a similarity smaller than a preconfigured value by comparing each of a value indicating the first similarity and a value indicating the second similarity with the preconfigured value.

17. The encoding device of claim 13, wherein the final prediction block is acquired by performing weight-averaging of the one or more prediction blocks and the first prediction block.

18. The encoding device of claim 13, wherein when the OBMC is applied to at least one block among the current sub-block, the second prediction block, and the third prediction block, deblocking filtering is not performed on the current sub-block.

19. The encoding device of claim 13, wherein the current sub-block is included in a coding block, and the current sub-block is a sub-block which does not include a boundary of the coding block,
the neighboring blocks are included in the coding block, and the neighboring blocks are sub-blocks including the boundary of the coding block, and
when the number of blocks to which the OBMC is applied among the neighboring blocks is smaller than a first value, the OBMC is not applied to the current sub-block.

20. A computer-readable non-transitory storage medium storing a bitstream, wherein the bitstream is decoded by a decoding method, and
the decoding method comprises:
acquiring first motion information of a current sub-block;
acquiring second motion information about a first neighboring block among neighboring blocks of the current sub-block;
acquiring third motion information about a second neighboring block among the neighboring blocks;
acquiring a first prediction block based on the first motion information;
acquiring a second prediction block based on the second motion information;
acquiring a third prediction block based on the third motion information;
identifying whether OBMC is applied to the current sub-block;
when the OBMC is applied to the current sub-block, selecting one or more prediction blocks which satisfy a preconfigured condition among the second prediction block and the third prediction block; and
performing the OBMC based on the one or more prediction blocks and the first prediction block to acquire a final prediction block for the current sub-block.
